(19) United States
(12) Patent Application Publication
(10) Pub. No.: US 2025/0306412 A1
(43) Pub. Date: Oct. 2, 2025

(54) LAMINATE, LIQUID CRYSTAL DISPLAY DEVICE, AND IN-VEHICLE DISPLAY

(71) Applicant: FUJIFILM Corporation, Tokyo (JP)

(72) Inventors: Naoya NISHIMURA, Kanagawa (JP); Fumitake MITOBE, Kanagawa (JP); Naoki KOITO, Kanagawa (JP)

(73) Assignee: FUJIFILM Corporation, Tokyo (JP)

(21) Appl. No.: 19/240,924

(22) Filed: Jun. 17, 2025

Related U.S. Application Data
(63) Continuation of application No. PCT/JP2023/043555, filed on Dec. 6, 2023.

(30) Foreign Application Priority Data
Dec. 19, 2022 (JP) 2022-202674

(51) Int. Cl. G02F 1/13; B60K 35/22; G02F 1/1335; G02F 1/13363; G02F 1/137

(52) U.S. Cl. CPC G02F 1/1323; B60K 35/22; G02F 1/133531; G02F 1/133638; G02F 1/13706

(57) ABSTRACT

The present invention provides a laminate where, as a member of a liquid crystal display device, a viewing angle of the device can be controlled, and has excellent light shielding and resistance properties. The laminate includes, in the following order, a first light absorption anisotropic layer, a first polarizer, a first liquid crystal cell, a second polarizer, a second liquid crystal cell, and a second light absorption anisotropic layer, in which an absorption axis of the first polarizer to the second polarizer is orthogonal, the first and second light absorption anisotropic layer contain a dichroic substance, an angle θ1 between a transmittance central axis and a normal direction of a surface of the first light absorption anisotropic layer is 0° to 45°, and an angle θ2 between a transmittance central axis and a normal direction of a surface of the second light absorption anisotropic layer is 0° to 45°.

### CROSS-REFERENCE TO RELATED APPLICATIONS

This application is a Continuation of PCT International Application No. PCT/JP2023/043555 filed on Dec. 6, 2023, which was published under PCT Article 21(2) in Japanese, and which claims priority under 35 U.S.C. § 119(a) to Japanese Patent Application No. 2022-202674 filed on Dec. 19, 2022. The above applications are hereby expressly incorporated by reference, in their entirety, into the present application.

### BACKGROUND OF THE INVENTION

### 1. Field of the Invention

The present invention relates to a laminate, a liquid crystal display device, and an in-vehicle display.

### 2. Description of the Related Art

In recent years, a display device such as a liquid crystal display device has been widely used as a display of a personal computer, a smartphone, or the like. In addition, the display is often employed in a mobile device. A device having such a display is often used in a public place, and a technique for preventing unauthorized viewing from others has been required.

In addition, in recent years, the liquid crystal display device is used as an in-vehicle display in a vehicle. With an increase in size of the in-vehicle display, images displayed on the display may be reflected on a windshield or the like, which may hinder a field of view of a driver, and thus a technique for preventing the reflected glare has been required.

In addition, in the above-described display, it is also preferable that a width of a viewing angle can be switched as necessary.

For example, WO2021/210359A discloses an optical laminate including, in the following order, at least a first light absorption anisotropic layer, a refractive index anisotropic layer containing a liquid crystal compound having one or more twisted structures, and a second light absorption anisotropic layer, in which the first light absorption anisotropic layer and the second light absorption anisotropic layer contain an anisotropic absorption material, and an absorption axis is aligned at an angle of 60° to 90° with respect to a film surface. In the above-described optical laminate, it is described that the liquid crystal compound having a twisted structure is replaced with a twisted nematic (TN) liquid crystal cell or a vertically aligned twisted nematic (VATN) liquid crystal cell, and refractive anisotropy of the liquid crystal layer is electrically controlled, whereby a narrow visual field and a wide visual field can be electrically controlled in the liquid crystal display device.

### SUMMARY OF THE INVENTION

Regarding the liquid crystal display device, it is desired that, in a case where the liquid crystal display device is visually recognized from an oblique direction at a specific azimuthal angle, an image of the liquid crystal display device is not always visually recognized, and in a case where the liquid crystal display device is visually recognized from an oblique direction at an azimuthal angle different from the specific azimuthal angle (for example, an azimuthal angle orthogonal to the specific azimuthal angle), it is possible to switch whether or not the image of the liquid crystal display device is visually recognized. In the liquid crystal display device having the above-described characteristics, in a case of being mounted in a vehicle, it is possible to switch visibility of the image of the liquid crystal display device from a seat of the driver or a seat of the passenger, while preventing the image from being reflected on the windshield. Hereinafter, the liquid crystal display device having the above-described characteristics (the image of the liquid crystal display device is not always visually recognized in a case where the liquid crystal display device is visually recognized from an oblique direction at a specific azimuthal angle, and the switching of whether or not the image of the liquid crystal display device is visually recognized can be performed in a case where the liquid crystal display device is visually recognized from an oblique direction at an azimuthal angle different from the specific azimuthal angle) is referred to as a liquid crystal display device “capable of controlling a viewing angle”.

In the liquid crystal display device as described above, in a mode in which the image cannot be visually recognized from an oblique direction, it is required that brightness in a case of being visually recognized from the oblique direction is sufficiently lower than brightness in a case of being visually recognized from a front direction. Hereinafter, such a characteristic is also referred to as “light shielding properties”.

In addition, since the liquid crystal display device as described above may be used in an environment in which sunlight or the like is irradiated, it is required that the above-described light shielding properties are maintained even after the light is irradiated for a long time. Hereinafter, the characteristic in which the above-described light shielding properties are maintained even after the light is irradiated for a long time will also be referred to as “light resistance”.

As a result of studying the optical laminate disclosed in WO2021/210359A, the present inventors have found that the above-described light shielding properties and the above-described light resistance cannot be achieved at the same time, and have found that there is room for further improvement.

Therefore, an object of the present invention is to provide a laminate in which, in a case of being adopted as a member of a liquid crystal display device, a viewing angle of the obtained liquid crystal display device can be controlled, light shielding properties of the obtained liquid crystal display device are excellent, and light resistance is excellent.

Another object of the present invention is to provide a liquid crystal display device using the above-described laminate, and an in-vehicle display.

The present inventors have completed the present invention as a result of intensive studies to solve the above-described problems. That is, the present inventors have found that the above-described objects can be achieved by the following configuration.

[2] A laminate comprising, in the following order:
a first light absorption anisotropic layer;
a first polarizer;
a first liquid crystal cell;
a second polarizer;
a second liquid crystal cell; and
a second light absorption anisotropic layer,
in which an absorption axis of the first polarizer is orthogonal to an absorption axis of the second polarizer,
the first light absorption anisotropic layer and the second light absorption anisotropic layer contain a dichroic substance,
an angle θ1 between a transmittance central axis of the first light absorption anisotropic layer and a normal direction of a surface of the first light absorption anisotropic layer is 0° to 45°, and
an angle θ2 between a transmittance central axis of the second light absorption anisotropic layer and a normal direction of a surface of the second light absorption anisotropic layer is 0° to 45°.

[2] The laminate according to [1],
in which the dichroic substance has an arrangement structure of dichroic substances in the first light absorption anisotropic layer and the second light absorption anisotropic layer.

[3] The laminate according to [1] or [2],
in which the first liquid crystal cell and the second liquid crystal cell are each independently selected from the group consisting of a twisted nematic type liquid crystal cell, an in-plane switching type liquid crystal cell, and a vertical alignment type liquid crystal cell.

[4] The laminate according to any one of [1] to [3],
in which the second liquid crystal cell is a liquid crystal cell capable of switching an in-plane phase difference of the second liquid crystal cell between 0 and λ/2, and
in a state in which the in-plane phase difference of the second liquid crystal cell is λ/2, an angle between an in-plane slow axis direction of the second liquid crystal cell and the absorption axis of the second polarizer is in a range of 45°±10°.

[5] The laminate according to any one of [1] to [3],
in which the second liquid crystal cell is a liquid crystal cell having an in-plane phase difference of λ/2 and capable of controlling an in-plane slow axis direction, and
the second liquid crystal cell is capable of controlling an in-plane slow axis such that an angle between the in-plane slow axis direction of the second liquid crystal cell and the absorption axis of the second polarizer is in a range of 45°±10° or in a range of 0°±10°.

[6] A liquid crystal display device comprising:
the laminate according to any one of [1] to [5].

[7] An in-vehicle display comprising:
the liquid crystal display device according to [6].

According to the present invention, it is possible to provide a laminate in which, in a case of being adopted as a member of a liquid crystal display device, a viewing angle of the obtained liquid crystal display device can be controlled, light shielding properties of the obtained liquid crystal display device are excellent, and light resistance is excellent.

In addition, according to the present invention, it is possible to provide a liquid crystal display device using the above-described laminate, and an in-vehicle display.

### BRIEF DESCRIPTION OF THE DRAWINGS

FIG. 1 is a schematic view showing an aspect of the liquid crystal display device according to the embodiment of the present invention.

FIG. 2 is a schematic cross-sectional view showing the aspect of the liquid crystal display device according to the embodiment of the present invention.

FIG. 3 is a schematic cross-sectional view showing the aspect of the liquid crystal display device according to the embodiment of the present invention.

FIG. 4 is a schematic cross-sectional view showing a change in polarization state in the liquid crystal display device according to the embodiment of the present invention.

FIG. 5 is a schematic cross-sectional view showing a change in polarization state in the liquid crystal display device according to the embodiment of the present invention.

FIG. 6 is a schematic cross-sectional view showing a change in polarization state in the liquid crystal display device according to the embodiment of the present invention.

FIG. 7 is a schematic cross-sectional view showing a change in polarization state in the liquid crystal display device according to the embodiment of the present invention.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained.

In the present specification, the numerical value range indicated by “to” means a range including numerical values before and after “to” as a lower limit value and an upper limit value, respectively.

In the present specification, the term parallel or orthogonal does not indicate parallel or orthogonal in a strict sense, but indicates a range of ±5° from parallel or orthogonal. In addition, in the present specification, a polar angle denotes an angle with respect to a normal direction of a film.

In addition, in the present specification, concepts of a liquid crystal composition and a liquid crystal compound also include those that no longer exhibit liquid crystallinity due to curing or the like.

In addition, in this specification, for each component, one kind of substance corresponding to each component may be used alone, or two or more kinds thereof may be used in combination. Here, in a case where two or more kinds of substances are used in combination for each component, the content of the component indicates the total content of the substances used in combination, unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In the present invention, refractive indices nx and ny are refractive indices in the in-plane direction of an optical member, and typically, nx represents a refractive index of a slow axis azimuth and ny represents a refractive index of a fast axis azimuth (that is, the azimuth orthogonal to the slow axis). In addition, nz represents a refractive index in a thickness direction. nx, ny, and nz can be measured, for example, with an Abbe refractometer (NAR-4T, manufactured by Atago Co., Ltd.) using a sodium lamp (λ=589 nm) as a light source. In addition, in a case of measuring wavelength dependence, it can be measured with a multi-wavelength Abbe refractometer DR-M2 (manufactured by Atago Co., Ltd.) in combination with a dichroic filter. In addition, values from Polymer Handbook (John Wiley & Sons, Inc.) and catalogs of various optical films can also be used.

In the present specification, Re(λ) and Rth(λ) respectively represent an in-plane retardation at a wavelength λ and a retardation at a wavelength λ in a thickness direction, and refractive indices nx, ny, and nz are represented by Equation (1) and Equation (2) using a film thickness d (μm).

$$Re ( λ ) = ( nx - ny ) \times d \times 1000 ( nm ) \qquad Equation ( 1 )$$

$$Rth ( λ ) = ( ( nx + ny ) / 2 - nz ) \times d \times 1000 ( nm ) \qquad Equation ( 2 )$$

The wavelength Δ is set to 550 nm unless otherwise specified.

The slow axis azimuth, Re (λ), and Rth (λ) can be measured using, for example, AxoScan OPMF-1 (manufactured by Opto Science Inc.).

In the present specification, Δnd is a phase difference generated by a layer in which a rod-like liquid crystal compound or a disk-like liquid crystal compound is twisted and aligned in a thickness direction as an axis, and is represented by a product of a thickness d of a liquid crystal layer and a birefringence index Δn of a liquid crystal. In addition, a twisted angle of the liquid crystal compound from one surface to the other surface of the layer in which the liquid crystal compound is twisted and aligned is also referred to as a twist angle of the liquid crystal compound.

In addition, unless otherwise specified, Δn is a value at a wavelength of 550 nm.

### <Laminate>

The laminate according to the embodiment of the present invention is a laminate including, in the following order, a first light absorption anisotropic layer, a first polarizer, a first liquid crystal cell, a second polarizer, a second liquid crystal cell, and a second light absorption anisotropic layer.

An absorption axis of the first polarizer is orthogonal to an absorption axis of the second polarizer.

In addition, the first light absorption anisotropic layer and the second light absorption anisotropic layer contain a dichroic substance. Here, an angle θ1 between a transmittance central axis of the first light absorption anisotropic layer and a normal direction of a surface of the first light absorption anisotropic layer is 0° to 45°, and an angle θ2 between a transmittance central axis of the second light absorption anisotropic layer and a normal direction of a surface of the second light absorption anisotropic layer is 0° to 45°.

The laminate according to the embodiment of the present invention is used as a member of a liquid crystal display device, and constitutes the liquid crystal display device according to the embodiment of the present invention.

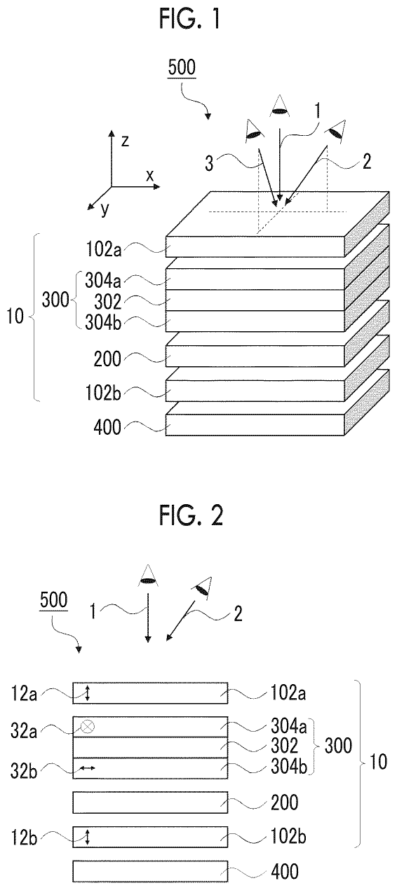

FIG. 1 is a schematic view showing an aspect of a liquid crystal display device using the laminate according to the embodiment of the present invention.

A liquid crystal display device 500 shown in FIG. 1 includes a laminate 10 and a plane light source 400 in this order from a viewing side. In FIG. 1, the viewing side is a side on which an arrow of a front viewing direction 1 is described.

In FIG. 1, the laminate 10 includes a first light absorption anisotropic layer 102a, a liquid crystal panel 300, a second liquid crystal cell 200, and a second light absorption anisotropic layer 102b in this order. The liquid crystal panel 300 includes a first polarizer 304a, a first liquid crystal cell 302, and a second polarizer 304b in this order from the viewing side.

In FIG. 1, the front viewing direction 1 is parallel to a z-axis direction. In addition, a first viewing direction 2 is a direction parallel to a zx plane, and a second viewing direction 3 is a direction parallel to a yz plane.

FIG. 2 is a schematic cross-sectional view of the liquid crystal display device 500 in a plane (plane parallel to the zx plane) including the front viewing direction 1 and the first viewing direction 2 in FIG. 1.

As shown in FIG. 2, in the liquid crystal display device 500, an absorption axis 32a of the first polarizer is orthogonal to an absorption axis 32b of the second polarizer. In addition, the absorption axis 32a of the first polarizer is parallel to a depth direction of the drawing plane in FIG. 2, and the absorption axis 32b of the second polarizer is orthogonal to the depth direction of the drawing plane in FIG. 2.

In addition, an angle θ1 between a transmittance central axis 12a of the first light absorption anisotropic layer 102a and a normal direction of a surface of the first light absorption anisotropic layer 102a is 0°. In addition, an angle θ2 between a transmittance central axis 12b of the second light absorption anisotropic layer 102b and a normal direction of a surface of the second light absorption anisotropic layer 102b is 0°.

In the liquid crystal display device 500 shown in FIGS. 1 and 2, an amount of light transmitted through each pixel of the liquid crystal panel 300 is adjusted by controlling an alignment direction of a liquid crystal compound in each pixel of the first liquid crystal cell 302, and thus an image is displayed.

In addition, in the liquid crystal display device 500 shown in FIGS. 1 and 2, the first liquid crystal cell 302 and the second liquid crystal cell 200 are twisted nematic type (TN type). In general, in the TN type liquid crystal cell, in a state in which no voltage is applied, the liquid crystal compound is twisted and aligned in a thickness direction of the first liquid crystal cell 302 or the second liquid crystal cell 200 as an axis.

Typically, in the above-described TN type liquid crystal cell, an alignment direction of the liquid crystal compound rotates by 90° from one surface of the liquid crystal cell to the other surface of the liquid crystal cell in the state in which no voltage is applied. In addition, typically, linearly polarized light incident into the TN type liquid crystal cell in the state in which no voltage is applied is rotated by 90°, and emitted from the TN type liquid crystal cell. In addition, typically, linearly polarized light incident into the TN type liquid crystal cell in a state in which a voltage is applied is emitted from the TN type liquid crystal cell while maintaining a polarization state.

Therefore, in a liquid crystal panel in which the typical TN type liquid crystal cell is disposed between two polarizing plates disposed in a crossed nicols, in the state in which no voltage is applied, the liquid crystal panel is in a white display in which light is transmitted.

In the liquid crystal display device 500 shown in FIG. 2, an image to be displayed can be visually recognized from the front viewing direction 1, and an image to be displayed cannot be visually recognized in the first viewing direction 2 at a position inclined from the front viewing direction 1 to the right side of the paper surface at an azimuthal angle orthogonal to the absorption axis of the first polarizer 304a. That is, light emitted from the liquid crystal display device 500 in the first viewing direction 2 is shielded.

The above-described principle will be described below.

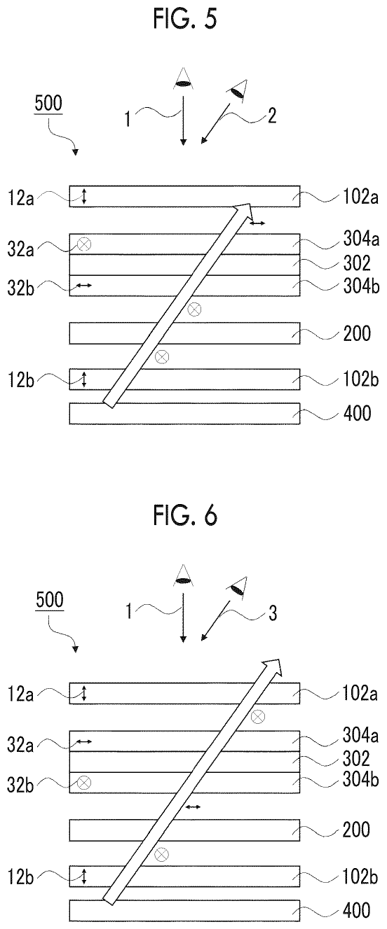

The change in polarization state in the first viewing direction 2 shown in FIG. 2 is shown in FIGS. 4 and 5. In FIGS. 4 and 5, a white arrow represents a transmitting polarized light component, and a direction shown between the respective layers represents a polarization direction of the transmitting polarized light component. Reference numerals of the respective configurations shown in FIGS. 4 and 5 are the same as those in FIGS. 1 and 2, and aspects thereof are the same as those in FIGS. 1 and 2.

As described below, FIG. 4 shows a change in polarization state in a state in which no voltage is applied to the first liquid crystal cell 302 and the second liquid crystal cell 200; and FIG. 5 shows a change in polarization state in a state in which no voltage is applied to the first liquid crystal cell 302 and a voltage is applied to the second liquid crystal cell 200.

First, the state in which a voltage is not applied to the first liquid crystal cell 302 and the second liquid crystal cell 200 will be described with reference to FIG. 2 (also refer to FIG. 4).

A part of light emitted from the plane light source 400 in the first viewing direction 2 is absorbed by the dichroic substance contained in the second light absorption anisotropic layer 102b. In this case, since the angle θ2 between the transmittance central axis 12b of the second light absorption anisotropic layer 102b and the normal direction of the surface of the second light absorption anisotropic layer 102b is 0°, a polarized light component in a direction orthogonal to the depth direction of the drawing plane is absorbed by the dichroic substance, and more of a polarized light component in the depth direction of the drawing plane in FIG. 2 is transmitted.

The polarized light component in the depth direction of the drawing plane in FIG. 2, which has been transmitted through the second light absorption anisotropic layer 102b, is rotated by 90° in the polarization direction by the second liquid crystal cell 200. As a result, the polarized light component emitted from the second liquid crystal cell 200 is in the same direction as the direction of the absorption axis 32b of the second polarizer 304b, and thus absorbed by the second polarizer 304b.

Therefore, in the state in which no voltage is applied to the first liquid crystal cell 302 and the second liquid crystal cell 200, the light emitted in the first viewing direction 2 is shielded.

Next, the state in which no voltage is applied to the first liquid crystal cell 302 and a voltage is applied to the second liquid crystal cell 200 will be described with reference to FIG. 2 (also refer to FIG. 5).

As in the state in which no voltage is applied to the first liquid crystal cell 302 and the second liquid crystal cell 200 described above, in the second light absorption anisotropic layer 102b, more of a polarized light component in the depth direction of the drawing plane in FIG. 2 is transmitted.

Here, in a case where a voltage is applied to the second liquid crystal cell 200, the polarization state of the light transmitted through the second liquid crystal cell 200 is maintained. Therefore, since the polarized light component transmitted through the second liquid crystal cell 200 is maintained in the depth direction of the drawing plane in FIG. 2, the polarized light component is not absorbed by the second polarizer 304b, but incident into the first liquid crystal cell 302. The polarized light component in the depth direction of the drawing plane in FIG. 2, which has been incident into the first liquid crystal cell 302, is rotated by 90° in direction, is incident into the first polarizer 304a, and transmits through the first polarizer 304a. Here, a polarization direction of the polarized light component emitted from the first polarizer 304a is a direction orthogonal to the depth direction of the drawing plane.

As a result, the polarized light component emitted from the first polarizer 304a is absorbed by the dichroic substance of the first light absorption anisotropic layer 102a. This is because the angle θ1 between the transmittance central axis 12a of the first light absorption anisotropic layer 102a and the normal direction of the surface of the first light absorption anisotropic layer 102a is 0°, and the polarized light component in the direction orthogonal to the depth direction of the drawing plane is easily absorbed.

Therefore, even in the state in which no voltage is applied to the first liquid crystal cell 302 and a voltage is applied to the second liquid crystal cell 200, the light emitted in the first viewing direction 2 is shielded.

In the above, the characteristics with the first viewing direction 2 at the position inclined to the right side of the paper surface from the front viewing direction 1 at the azimuthal angle orthogonal to the absorption axis of the first polarizer 304a have been described. However, even in a case where the light is visually recognized from a viewing direction at a position inclined to the left side of the paper surface from the front viewing direction 1 at the azimuthal angle orthogonal to the absorption axis of the first polarizer 304a, the same mechanism as that in the case where the light is visually recognized from the first viewing direction 2 occurs, and thus the light is shielded.

That is, in the liquid crystal display device 500 shown in FIG. 2, in a case where the liquid crystal display device 500 is visually recognized from an oblique direction in a direction orthogonal to the absorption axis of the first polarizer 304a, the image displayed on the liquid crystal display device 500 is shielded.

Next, a case where the liquid crystal display device 500 shown in FIG. 1 is viewed from the second viewing direction 3 will be described.

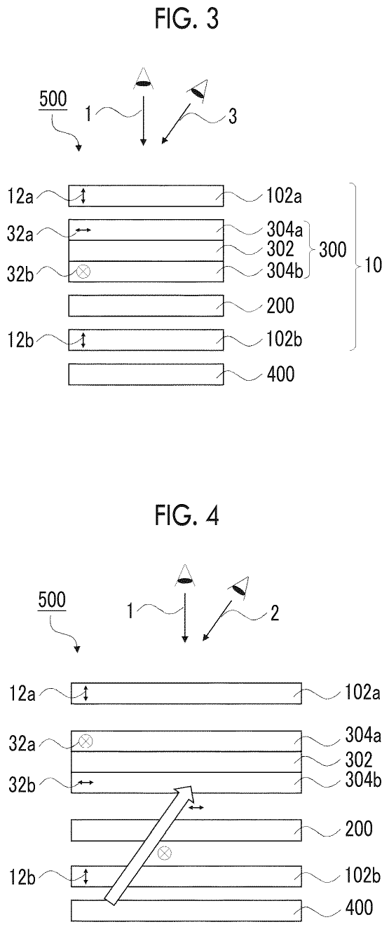

FIG. 3 is a schematic cross-sectional view of the liquid crystal display device 500 in a plane (plane parallel to the yz plane) including the front viewing direction 1 and the second viewing direction 3 in FIG. 1. The liquid crystal display device 500 shown in FIG. 3 is the same as the liquid crystal display device shown in FIGS. 1 and 2, and only directions shown in a cross section are different. Therefore, reference numerals of the respective configurations shown in FIG. 3 are the same as those in FIGS. 1 and 2, and aspects thereof are the same as those in FIGS. 1 and 2. The directions of the absorption axis 32a of the first polarizer 304a and the absorption axis 32b of the second polarizer 304b are rotated by 90° from those shown in FIG. 2.

In the liquid crystal display device 500 shown in FIG. 3, an image to be displayed can be visually recognized from the front viewing direction 1, and it is possible to switch between whether or not an image to be displayed can be visually recognized in the second viewing direction 3 at a position inclined from the front viewing direction 1 to the right side of the paper surface at an azimuthal angle parallel to the absorption axis of the first polarizer 304a. That is, it is possible to switch whether or not the light emitted from the liquid crystal display device 500 in the second viewing direction 3 is shielded.

The above-described principle will be described below.

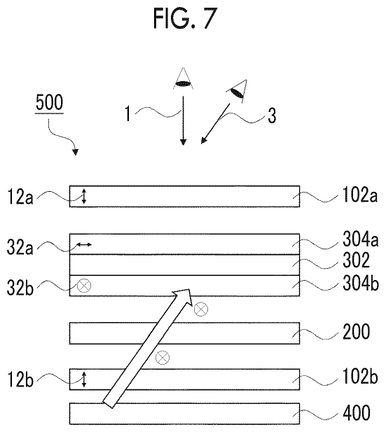

The change in polarization state in the second viewing direction 3 shown in FIG. 3 is shown in FIGS. 6 and 7. In FIGS. 6 and 7, a white arrow represents a polarized light component transmitted in the second viewing direction 3, and a direction shown between the respective layers represents a polarization direction of the transmitting polarized light component. Reference numerals of the respective configurations shown in FIGS. 6 and 7 are the same as those in FIGS. 1 to 3, and aspects thereof are the same as those in FIGS. 1 to 3.

As described below, FIG. 6 shows a change in polarization state in a state in which no voltage is applied to the first liquid crystal cell 302 and the second liquid crystal cell 200; and FIG. 7 shows a change in polarization state in a state in which no voltage is applied to the first liquid crystal cell 302 and a voltage is applied to the second liquid crystal cell 200.

First, the state in which a voltage is not applied to the first liquid crystal cell 302 and the second liquid crystal cell 200 will be described with reference to FIG. 3 (also refer to FIG. 6).

A part of light emitted from the plane light source 400 in the second viewing direction 3 is absorbed by the dichroic substance contained in the second light absorption anisotropic layer 102b. In this case, as in the case of FIG. 2, more of a polarized light component in the depth direction of the drawing plane in FIG. 3 is transmitted.

The polarized light component in the depth direction of the drawing plane in FIG. 3, which has been transmitted through the second light absorption anisotropic layer 102b, is rotated by 90° in the polarization direction by the second liquid crystal cell 200. As a result, the polarized light component emitted from the second liquid crystal cell 200 is in a direction orthogonal to the direction of the absorption axis 32b of the second polarizer 304b, and thus transmits through the second polarizer 304b.

The polarized light component transmitted through the second polarizer 304b is rotated by 90° in direction by the first liquid crystal cell 302, is incident into the first polarizer 304a, and transmits through the first polarizer 304a. Here, a polarization direction of the polarized light component emitted from the first polarizer 304a is the depth direction of the drawing plane.

The polarized light component emitted from the first polarizer 304a is incident into the first light absorption anisotropic layer 102a; but since the polarization direction of the polarized light component is the depth direction of the drawing plane and a direction orthogonal to the transmittance central axis 12a, the polarized light component is transmitted without being absorbed by the dichroic substance contained in the first light absorption anisotropic layer 102a.

Therefore, in the state in which no voltage is applied to the first liquid crystal cell 302 and the second liquid crystal cell 200, the light emitted in the second viewing direction 3 is transmitted.

Next, the state in which no voltage is applied to the first liquid crystal cell 302 and a voltage is applied to the second liquid crystal cell 200 will be described with reference to FIG. 3 (also refer to FIG. 7).

As in the state in which no voltage is applied to the first liquid crystal cell 302 and the second liquid crystal cell 200 described above, in the second light absorption anisotropic layer 102b, more of a polarized light component in the depth direction of the drawing plane in FIG. 3 is transmitted.

Here, in a case where a voltage is applied to the second liquid crystal cell 200, the polarization state of the light transmitted through the second liquid crystal cell 200 is maintained. As a result, a polarization direction of the polarized light component emitted from the second liquid crystal cell 200 is the depth direction of the drawing plane in FIG. 3, so that the polarized light component is in the same direction as the direction of the absorption axis 32b of the second polarizer 304b, and thus absorbed by the second polarizer 304b.

Therefore, in the state in which no voltage is applied to the first liquid crystal cell 302 and a voltage is applied to the second liquid crystal cell 200, the light emitted in the second viewing direction 3 is shielded.

In the above, the characteristics with the second viewing direction 3 at the position inclined to the right side of the paper surface from the front viewing direction 1 at the azimuthal angle parallel to the absorption axis of the first polarizer 304a have been described. However, even in a case where the light is visually recognized from a viewing direction at a position inclined to the left side of the paper surface from the front viewing direction 1 at the azimuthal angle parallel to the absorption axis of the first polarizer 304a, the same mechanism as that in the case where the light is visually recognized from the second viewing direction 3 occurs.

The light emitted in the front viewing direction 1 is emitted without being shielded. The reason for this will be described below. Here, the state in which a voltage is not applied to the first liquid crystal cell 302 and the second liquid crystal cell 200 will be described with reference to FIG. 2.

First, the front viewing direction 1 is parallel to the transmittance central axis 12b of the second light absorption anisotropic layer 102b. Therefore, the light incident into the second polarizer 304b includes the polarized light component in the depth direction of the drawing plane in FIG. 2 and the polarized light component in the direction orthogonal to the depth direction of the drawing plane in FIG. 2. Among the light incident into the second polarizer 304b in the front viewing direction 1, a polarized light component in a direction parallel to the absorption axis 32b of the second polarizer 304b is absorbed, but a polarized light component in a direction orthogonal to the absorption axis 32b transmits through the second polarizer 304b. Next, a polarization direction of the polarized light component incident into the first liquid crystal cell 302 is rotated by 90° by the first liquid crystal cell 302. Therefore, the polarized light component transmits through the first polarizer 304a. In addition, since the front viewing direction 1 is parallel to the transmittance central axis 12a of the first light absorption anisotropic layer 102a, the polarized light component emitted in the front viewing direction 1 is emitted without being absorbed by the first light absorption anisotropic layer 102a.

Therefore, in the state in which no voltage is applied to the first liquid crystal cell 302 and the second liquid crystal cell 200, the light emitted in the front viewing direction 1 is transmitted.

In addition, even in the state in which a voltage is applied to the second liquid crystal cell 200, the polarization direction is not changed. Therefore, the light incident into the second polarizer 304b includes the polarized light component in the depth direction of the drawing plane in FIG. 2 and the polarized light component in the direction orthogonal to the depth direction of the drawing plane in FIG. 2. Accordingly, the light emitted in the front viewing direction 1 is transmitted as in the state in which no voltage is applied to the second liquid crystal cell 200.

As described above, in the liquid crystal display device using the laminate according to the embodiment of the present invention, the light emitted in the front viewing direction 1 of FIGS. 1 and 2 is emitted from the liquid crystal display device, and the light emitted in the first viewing direction 2 is shielded regardless of whether or not a voltage is applied to the second liquid crystal cell 200. In addition, the light emitted in the second viewing direction 3 of FIGS. 1 and 3 can be switched between light shielding and emission, depending on whether or not a voltage is applied to the second liquid crystal cell 200.

Here, in the laminate according to the embodiment of the present invention, the light shielding properties of the obtained liquid crystal display device are excellent. Specifically, the light in the second viewing direction 3 in FIG. 1 is difficult to transmit in the state in which a voltage is applied to the second liquid crystal cell 200, and the light in the first viewing direction 2 in FIG. 1 is difficult to transmit regardless of whether or not a voltage is applied to the second liquid crystal cell 200.

The above-described reason is not always clear, but the present inventors have presumed as follows. In the laminate 10 according to the embodiment of the present invention, the first light absorption anisotropic layer 102a is disposed on the most viewing side. In the liquid crystal panel 300, scattering which causes the change in polarization state may occur; but even in a case where such scattering occurs, light scattered by the first light absorption anisotropic layer 102a can be absorbed. Therefore, it is considered that the light shielding properties of the obtained liquid crystal display device are excellent.

In addition, the laminate according to the embodiment of the present invention has excellent light resistance.

The above-described reason is not always clear, but the present inventors have presumed as follows. As shown in FIGS. 1 to 3, in the laminate 10 according to the embodiment of the present invention, the second light absorption anisotropic layer 102b is disposed on a side opposite to the most viewing side. Therefore, in a case where the laminate is irradiated with external light, the external light is likely to be absorbed by the other layer until the external light reaches the second light absorption anisotropic layer 102b. In this case, it is considered that the second light absorption anisotropic layer 102b is less likely to be deteriorated due to the external light, and as a result, the obtained liquid crystal display device has excellent light resistance.

The aspects shown in FIGS. 1 to 3 are aspects of the present invention, and the present invention is not limited to the above-described aspects.

For example, in a case where the laminating direction of the liquid crystal panel 300 in the laminate 10 is rotated by 90°, light can be switched between light shielding and emission in the first viewing direction 2 in FIG. 1, and light emitted in the second viewing direction 3 is shielded.

In addition, the first liquid crystal cell 302 and the second liquid crystal cell 200 may be liquid crystal cells of different types.

In addition, it is sufficient that the angle θ1 between the transmittance central axis 12a of the first light absorption anisotropic layer 102a and the normal direction of the surface of the first light absorption anisotropic layer 102a is 0° to 45°, and the angle θ1 can be adjusted according to a direction in which the image is desired to be visually recognized. In addition, it is sufficient that the angle θ2 between the transmittance central axis 12b of the second light absorption anisotropic layer 102b and the normal direction of the surface of the second light absorption anisotropic layer 102b is 0° to 45°, and the angle θ2 can be adjusted according to a direction in which the image is desired to be visually recognized.

Hereinafter, the configuration of the laminate will be described. In the aspects shown in FIGS. 1 to 3 and the above-described aspects, each configuration included in the laminate can be changed as an example of each configuration shown below, and the changed configurations can also be combined.

### [First Light Absorption Anisotropic Layer]

The first light absorption anisotropic layer in the laminate according to the embodiment of the present invention contains a dichroic substance, and the angle θ1 between the transmittance central axis of the first light absorption anisotropic layer and the normal direction of the surface of the first light absorption anisotropic layer is 0° to 45°. The transmittance central axis usually coincide with an alignment direction of the dichroic substance.

As described above, the above-described angle θ1 can be adjusted according to the direction in which the image is desired to be visually recognized. For example, in a case where a function of preventing unauthorized viewing is imparted to the liquid crystal display device, it is preferable to maximize a transmittance in the front direction. In this case, the above-described angle θ1 is preferably 0° to 10°.

In addition, the transmittance central axis of the first light absorption anisotropic layer may be set to different directions depending on a location of the first light absorption anisotropic layer in a plane. For example, in an in-vehicle display in which a display surface is a curved surface, in order to prevent emitted light from any position from being reflected from the windshield or the like and to allow the driver to appropriately recognize the display image, it is preferable to adjust the direction of the transmittance central axis of the first light absorption anisotropic layer to match the curved surface.

The above-described transmittance central axis denotes a direction in which the transmittance is highest in a case where a transmittance is measured by changing an inclination angle (polar angle) and an inclination direction (azimuthal angle) with respect to the normal direction of the surface of the first light absorption anisotropic layer. In a case of measuring the above-described angle θ1, first, a direction of an azimuthal angle in which the transmittance central axis is inclined is detected using AxoScan OPMF-1 (manufactured by Opto Science Inc.), the transmittance is derived by measuring Mueller matrix while various polar angles are changed in the direction of the azimuthal angle, and a direction (polar angle) having the highest transmittance is defined as the direction of the transmittance central axis of the light absorption anisotropic layer. The direction of the polar angle is the angle between the transmittance central axis of the light absorption anisotropic layer and the normal direction of the light absorption anisotropic layer.

The transmittance central axis (polar angle) of the first light absorption anisotropic layer is measured at 15 sites optionally selected in the first light absorption anisotropic layer, and an average value of the polar angles is defined as the transmittance central axis of the first light absorption anisotropic layer.

In addition, in the present invention, the optical measurement is performed using light having a wavelength of 550 nm, unless otherwise specified.

A transmittance of light in the direction parallel to the transmittance central axis of the first light absorption anisotropic layer is preferably 50% or more, and more preferably 70% or more. The upper limit of the transmittance is not particularly limited, but is, for example, 95% or less and is often 90% or less.

A transmittance in a direction inclined by 30° from the transmittance central axis of the first light absorption anisotropic layer is preferably 30% or less, and more preferably 15% or less. The lower limit of the transmittance is not particularly limited, but is, for example, 0.5% or more and is often 5% or more.

The first light absorption anisotropic layer according to the present invention includes a layer containing at least one dichroic substance (for example, a dichroic coloring agent). Hereinafter, a dichroic coloring agent will be described as an example of the dichroic substance.

### (Dichroic Coloring Agent)

The dichroic substance contained in the first light absorption anisotropic layer according to the present invention is not particularly limited as long as it is a substance exhibiting dichroism; and examples thereof include a dichroic coloring agent, a dichroic azo coloring agent compound, an ultraviolet absorbing substance, an infrared absorbing substance, a non-linear optical substance, a carbon nanotube, an anisotropic metal nanoparticle, and an inorganic substance.

The first light absorption anisotropic layer can also contain two or more kinds of the dichroic substances. For example, it is preferable that the first light absorption anisotropic layer contains a cyan coloring agent exhibiting dichroism in a wavelength range of a red color, a magenta coloring agent exhibiting dichroism in a wavelength range of a green color, and a yellow coloring agent exhibiting dichroism in a wavelength range of a blue color. In a case where the first light absorption anisotropic layer contains a plurality of kinds of dichroic substances, the tint can be made neutral and the viewing angle control effect can be exhibited over the entire wavelength range of visible light.

The dichroic substance is a substance exhibiting dichroism, and the dichroism denotes a property in which an absorbance varies depending on the polarization direction.

An alignment degree of the dichroic substance at a wavelength of 550 nm is preferably 0.95 or more. In a case where the alignment degree of the dichroic substance is 0.95 or more, the transmittance in the direction of the absorption axis (that is, the direction in which light is expected to be transmitted) can be increased. In addition, from the viewpoint that the tint can be made neutral, an alignment degree of the dichroic substance at a wavelength of 420 nm is preferably 0.93 or more.

A thickness of the first light absorption anisotropic layer is not particularly limited, but from the viewpoint of flexibility, it is preferably 100 to 8,000 nm and more preferably 300 to 5,000 nm.

As the dichroic substance, a dichroic coloring agent is preferable, and a dichroic azo coloring agent compound is more preferable.

In the present invention, the dichroic azo coloring agent compound refers to an azo coloring agent compound in which an absorbance varies depending on directions.

The dichroic azo coloring agent compound may or may not exhibit liquid crystallinity.

In a case where the dichroic azo coloring agent compound exhibits liquid crystallinity, a nematic liquid crystal phase or a smectic liquid crystal phase may be exhibited. A temperature range at which the liquid crystal phase is exhibited is preferably room temperature (approximately 20° C. to 28° C.) to 300° C., and from the viewpoint of handleability and manufacturing suitability, it is more preferably 50° C. to 200° C.

In the present invention, from the viewpoint of further improving pressure resistance, it is preferable that, in a composition for forming a light absorption anisotropic layer described later, which is used in forming the first light absorption anisotropic layer, the dichroic azo coloring agent compound has a crosslinkable group.

Specific examples of the crosslinkable group include a (meth)acryloyl group, an epoxy group, an oxetanyl group, and a styryl group; and among these, a (meth)acryloyl group is preferable.

Preferred examples of the dichroic azo coloring agent compound used in the present invention include a first dichroic azo coloring agent compound, a second dichroic azo coloring agent compound, and a third dichroic azo coloring agent compound.

The first dichroic azo coloring agent compound is a dichroic azo coloring agent compound having a maximum absorption wavelength in a wavelength range of 560 nm or more and 700 nm or less. In addition, the second dichroic azo coloring agent compound is a dichroic azo coloring agent compound having a maximum absorption wavelength in a wavelength range of 455 nm or more and less than 560 nm. The third dichroic azo coloring agent compound is a dichroic azo coloring agent compound having a maximum absorption wavelength in a wavelength range of 380 nm or more and 455 nm or less.

Specific examples of the first dichroic azo coloring agent compound, the second dichroic azo coloring agent compound, and the third dichroic azo coloring agent compound include compounds described in paragraphs [0161] to [0171] of WO2022/138548A, compounds described in paragraphs [0172] to [0180] of WO2022/138548A, and compounds described in paragraphs [0183] to [0206] of WO2022/138548A.

A content of the dichroic substance is preferably 1% to 30% by mass, more preferably 5% to 25% by mass, and still more preferably 10% to 20% by mass with respect to the total solid content mass of the first light absorption anisotropic layer.

In addition, in the first light absorption anisotropic layer according to the present invention, from the viewpoint of increasing the alignment degree, it is preferable that the dichroic substance contained in the light absorption anisotropic layer forms an arrangement structure.

Here, the arrangement structure refers to a state in which, in the light absorption anisotropic layer, the dichroic substances are collected to form an aggregate and molecules of the dichroic substances are periodically arranged in the aggregate.

The arrangement structure may be composed of only the dichroic substance, or may be composed of a liquid crystal compound described later and the dichroic substance. In addition, the arrangement structure may be composed of one kind of the dichroic substance, or may be composed of a plurality of kinds of the dichroic substances.

An arrangement structure composed of a certain kind of the dichroic substance and an arrangement structure composed of another kind of the dichroic substance may coexist in the light absorption anisotropic layer.

In addition, in a case where the light absorption anisotropic layer contains a plurality of kinds of dichroic substances, among the plurality of kinds of dichroic substances contained in the light absorption anisotropic layer, all of the plurality of kinds of dichroic substances may form the arrangement structure, or some kinds of dichroic substances may form the arrangement structure.

In the present invention, from the reason that the alignment degree of the first light absorption anisotropic layer is further increased, in a cross section of the first light absorption anisotropic layer observed with a scanning transmission electron microscope, in a case where a length of a major axis of the above-described arrangement structure is denoted by L and a length of a minor axis of the arrangement structure is denoted by D, it is preferable that 3 or more arrangement structures satisfying L≥240 nm are observed per 40 μm², it is more preferable that 3 to 15 arrangement structures are observed, and it is still more preferable that 3 to 10 arrangement structures are observed.

Here, the cross section is observed with the scanning transmission electron microscope (hereinafter, also abbreviated as “STEM”) as follows.

First, the first light absorption anisotropic layer is cut using an ultramicrotome to produce an ultra-thin section having a thickness of 100 nm in the film thickness direction.

Next, the ultra-thin section is placed on a grid with a carbon support film for STEM observation.

Thereafter, the grid is placed in the scanning transmission electron microscope, and a cross section is observed at an electron beam acceleration voltage of 30 kV.

In addition, the length L of the major axis of the arrangement structure and the length D of the minor axis of the arrangement structure are specifically measured as follows.

First, as described above, the cross section of the first light absorption anisotropic layer is observed with STEM, a captured image is analyzed to create a frequency histogram, and a frequency at which the frequency is maximized and a standard deviation of a frequency distribution are acquired.

Next, a frequency at which the frequency is 1.3 times the standard deviation on a dark side from the frequency at which the frequency is maximized is set as a threshold value.

Next, an image in which the brightness is binarized is created using the threshold value, and a portion having a major axis of 30 nm or more in the binarized dark region is extracted as the arrangement structure.

Furthermore, each of the extracted arrangement structures is approximated to an ellipse, a length of a major axis of the approximated ellipse is defined as the length L of the major axis of the arrangement structure, and a length of a minor axis of the approximated ellipse is defined as the length D of the minor axis of the arrangement structure.

The length L of the major axis of the arrangement structure and the length D of the minor axis of the arrangement structure may be measured using known image processing software. Examples of the image processing software include image processing software “ImageJ”.

### (Liquid Crystal Compound)

It is also preferable that the first light absorption anisotropic layer is formed of a liquid crystal composition containing the dichroic substance and a liquid crystal compound. Therefore, it is preferable that the first light absorption anisotropic layer contains a component derived from the liquid crystal compound.

In a case where the first light absorption anisotropic layer is formed of the above-described liquid crystal composition, the dichroic substance can be aligned at a high alignment degree while suppressing precipitation of the dichroic substance.

As the liquid crystal compound, a low-molecular-weight liquid crystal compound or a high-molecular-weight liquid crystal compound can also be used, and it is preferable that both are used in combination. Here, the “low-molecular-weight liquid crystal compound” refers to a liquid crystal compound having no repeating unit in the chemical structure. In addition, the “high-molecular-weight liquid crystal compound” refers to a liquid crystal compound having a repeating unit in the chemical structure.

The low-molecular-weight liquid crystal compound may be a compound exhibiting a nematic liquid crystal phase or a compound exhibiting a smectic liquid crystal phase, but from the viewpoint of increasing the alignment degree, a compound exhibiting a smectic liquid crystal phase is preferable. Examples thereof include liquid crystal compounds described in JP2013-228706A.

Examples of the high-molecular-weight liquid crystal compound include thermotropic liquid crystalline polymers described in JP2011-237513A. In addition, from the viewpoint of enhancing a strength (particularly, bending resistance of the film), it is preferable that the high-molecular-weight liquid crystal compound has a repeating unit having a crosslinkable group at the terminal. Examples of the crosslinkable group include polymerizable groups described in paragraphs [0040] to [0050] of JP2010-244038A. Among these, from the viewpoint of improving reactivity and synthetic suitability, an acryloyl group, a methacryloyl group, an epoxy group, an oxetanyl group, or a styryl group is preferable, and an acryloyl group or a methacryloyl group is more preferable.

In a case where the first light absorption anisotropic layer contains the high-molecular-weight liquid crystal compound, it is preferable that the high-molecular-weight liquid crystal compound forms a nematic liquid crystal phase. A temperature range at which the nematic liquid crystal phase is exhibited is preferably room temperature (23° C.) to 450° C., and more preferably 50° C. to 400° C. from the viewpoint of handleability and manufacturing suitability.

A content of the component derived from the liquid crystal compound in the first light absorption anisotropic layer is preferably 25 to 2,000 parts by mass, more preferably 100 to 1,300 parts by mass, and still more preferably 200 to 900 parts by mass with respect to 100 parts by mass of the content of the dichroic substance. In a case where the content of the liquid crystal compound is within the above-described range, the alignment degree of the dichroic substance is further improved.

The liquid crystal compound may be contained only one kind or two or more kinds. In a case of containing two or more kinds of the liquid crystal compounds, the above-described content of the component derived from the liquid crystal compound means the total content of the liquid crystal compounds.

### (Additive)

The liquid crystal composition used for forming the first light absorption anisotropic layer may further contain an additive such as a solvent, a vertical alignment agent, an interface improver, a leveling agent, a polymerizable component, a polymerization initiator (for example, a radical polymerization initiator), and a durability improver. Known additives can be appropriately used as the additive.

The laminate according to the embodiment of the present invention may include a layer different from the first light absorption anisotropic layer and layers described below. Here, other layers are layers which are in direct contact with the first light absorption anisotropic layer or in indirect contact with the first light absorption anisotropic layer through a layer different from the first light absorption anisotropic layer and layers described below. Hereinafter, the other layers which are in direct or indirect contact with the first light absorption anisotropic layer will be described.

### (Base Material Layer)

The laminate according to the embodiment of the present invention may include a base material layer as the other layers.

The base material layer is not particularly limited, but a transparent film or sheet is preferable; and examples thereof include known transparent resin films, transparent resin plates, transparent resin sheets, and glass. As the transparent resin film, a cellulose acylate film (such as a cellulose triacetate film, a cellulose diacetate film, a cellulose acetate butyrate film, and a cellulose acetate propionate film), a polyethylene terephthalate film, a polyether sulfone film, a polyacrylic resin film, a polyurethane-based resin film, a polyester film, a polycarbonate film, a polysulfone film, a polyether film, a polymethylpentene film, a polyetherketone film, a (meth)acrylonitrile film, or the like can be used.

Among these, a cellulose acylate film which is highly transparent, has a small optical birefringence, is easily produced, and is typically used as a protective film of a polarizing plate is preferable, and a cellulose triacetate film is particularly preferable.

A thickness of the transparent resin film is preferably 20 μm to 100 μm.

### (Alignment Film)

The laminate according to the embodiment of the present invention may include an alignment film between the base material layer and the first light absorption anisotropic layer as the other layers.

The alignment film may be any layer as long as the dichroic substance (liquid crystal compound) can be in a desired alignment state on the alignment film.

For example, a film formed of a polyfunctional acrylate compound or polyvinyl alcohol may be used. In particular, polyvinyl alcohol is preferable.

The alignment film may be a photo-alignment film. In addition, by irradiating a photo-alignment film containing an azo compound or a cinnamoyl compound with UV light from an oblique direction, the dichroic substance can be aligned in a state of being inclined with respect to a normal direction of the film.

### (Barrier Layer)

The laminate according to the embodiment of the present invention may include a barrier layer as the other layers.

Here, the barrier layer is also referred to as a gas-shielding layer (oxygen-shielding layer), and has a function of protecting the first light absorption anisotropic layer from gas such as oxygen in the atmosphere, the moisture, or the compound contained in an adjacent layer.

The barrier layer can refer to, for example, the description in paragraphs [0014] to [0054] of JP2014-159124A, paragraphs [0042] to [0075] of JP2017-121721A, paragraphs [0045] to [0054] of JP2017-115076A, paragraphs [0010] to [0061] of JP2012-213938A, and paragraphs [0021] to [0031] of JP2005-169994A.

### (Refractive Index Adjusting Layer)

In the first light absorption anisotropic layer, internal reflection due to a high refractive index of the first light absorption anisotropic layer may be a problem. In that case, a refractive index adjusting layer may be used. The refractive index adjusting layer is preferably a layer which is disposed to be in contact with the first light absorption anisotropic layer and is for so-called index matching. An in-plane average refractive index of the refractive index adjusting layer at a wavelength of 550 nm is preferably 1.55 or more and 1.70 or less.

### (Method of Forming First Light Absorption Anisotropic Layer)

A method of forming the first light absorption anisotropic layer is not particularly limited, and examples thereof include a method including, in the following order, a step of applying a composition for forming a light absorption anisotropic layer to form a coating film (hereinafter, also referred to as “coating film forming step”) and a step of aligning the liquid crystalline component or the dichroic substance, contained in the coating film (hereinafter, also referred to as “alignment step”).

In a case where the above-described dichroic substance has liquid crystallinity, the liquid crystalline component is a component which also includes the dichroic substance having liquid crystallinity, in addition to the above-described liquid crystal compound.

### —Coating Film Forming Step—

The coating film forming step is a step of applying the composition for forming a light absorption anisotropic layer to form a coating film.

The composition for forming a light absorption anisotropic layer can be easily applied by using a composition for forming a light absorption anisotropic layer, which contains a solvent, or using a liquid such as a melt obtained by heating the composition for forming a light absorption anisotropic layer.

Specific examples of the method of applying the composition for forming a light absorption anisotropic layer include known methods such as a roll coating method, a gravure printing method, a spin coating method, a wire bar coating method, an extrusion coating method, a direct gravure coating method, a reverse gravure coating method, a die-coating method, a spraying method, and an ink jet method.

### —Alignment Step—

The alignment step is a step of aligning the liquid crystalline component contained in the coating film. In this manner, the first light absorption anisotropic layer is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the liquid crystalline component contained in the composition for forming a light absorption anisotropic layer may be aligned by the coating film forming step or the drying treatment described above. For example, in an aspect in which the composition for forming a light absorption anisotropic layer is prepared as a coating liquid containing a solvent, a coating film having light absorption anisotropy (that is, the first light absorption anisotropic layer) is obtained by drying the coating film and removing the solvent from the coating film.

In a case where the drying treatment is performed at a temperature equal to or higher than a transition temperature of the liquid crystalline component contained in the coating film from a liquid crystal phase to an isotropic phase, a heat treatment described below may not be performed.

From the viewpoint of manufacturing suitability or the like, a transition temperature of the liquid crystalline component contained in the coating film from the liquid crystal phase to the isotropic phase is preferably 10° C. to 250° C. and more preferably 25° C. to 190° C. In a case where the transition temperature is 10° C. or higher, a cooling treatment or the like for lowering the temperature to a temperature range in which the liquid crystal phase is exhibited is not necessary, which is preferable. In addition, in a case where the transition temperature is 250° C. or lower, a high temperature is not required even in a case where the coating film is heated until the phase transition to the isotropic phase is made for the purpose of suppressing alignment defects and waste of thermal energy and deformation and deterioration of the substrate can be reduced, which is preferable.

It is preferable that the alignment step includes a heat treatment. In this manner, since the liquid crystalline component contained in the coating film can be aligned, the coating film after being subjected to the heat treatment can be suitably used as the light absorption anisotropic layer.

From the viewpoint of the manufacturing suitability or the like, the heat treatment is performed at a temperature of preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). In this manner, the alignment of the liquid crystalline component contained in the coating film can be fixed. A cooling unit is not particularly limited, and the cooling treatment can be performed according to a known method.

### —Other Steps—

The method of forming the first light absorption anisotropic layer may include a step of curing the first light absorption anisotropic layer after the above-described alignment step (hereinafter, also referred to as “curing step”).

The curing step is performed by heating the first light absorption anisotropic layer and/or irradiating the first light absorption anisotropic layer with light (exposing the first light absorption anisotropic layer to light), for example, in a case where the compound contained in the first light absorption anisotropic layer has a crosslinkable group (polymerizable group). Among these, from the viewpoint of productivity, it is preferable that the curing step is performed by irradiating the first light absorption anisotropic layer with light.

Various light sources such as infrared rays, visible light, and ultraviolet rays can be used as a light source for the curing, but ultraviolet rays are preferable. In addition, ultraviolet rays may be applied while the first light absorption anisotropic layer is heated during the curing, or ultraviolet rays may be applied through a filter which transmits only a specific wavelength.

In a case where the exposure is performed while the first light absorption anisotropic layer is heated, the heating temperature during the exposure depends on the transition temperature of the liquid crystalline component contained in the liquid crystal film, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

The first light absorption anisotropic layer may be a layer which contains the dichroic coloring agent and a guest-host liquid crystal material and can electrically drive the alignment direction of the dichroic coloring agent, as described in, for example, JP2013-541727A. In this case, it is possible to electrically switch the alignment direction of the dichroic coloring agent.

### [First Polarizer]

The first polarizer included in the laminate according to the embodiment of the present invention is not particularly limited, and a known polarizer (linear polarizer) can be used.

The absorption axis of the first polarizer is orthogonal to the absorption axis of the second polarizer described later.

Examples of the linear polarizer (absorption polarizer) include a polarizer in which a dichroic substance is dyed and stretched on a polyvinyl alcohol or other polymer resins to be horizontally aligned, and a polarizer in which a dichroic substance is horizontally aligned by aligning properties of liquid crystals.

In addition, the first polarizer may be a reflective polarizer, or a laminate of an absorptive polarizer and a reflective polarizer. The reflective polarizer is a polarizer which reflects one polarized light and transmits the other polarized light. The reflective polarizer has a reflection axis and a transmission axis in a plane, but since the reflection axis functions in the same manner as an absorption axis in a typical polarizer (absorption polarizer) in the sense that it does not transmit polarized light in the azimuth thereof, in the present specification, the reflection axis of the reflective polarizer can be read as the absorption axis.

### [First Liquid Crystal Cell]

The first liquid crystal cell included in the laminate according to the embodiment of the present invention is disposed between the first polarizer and the second polarizer, and adjusts the amount of light transmitted through the liquid crystal panel consisting of the first polarizer, the first liquid crystal cell, and the second polarizer.

The first liquid crystal cell is not particularly limited as long as the amount of light transmitted through the liquid crystal panel can be adjusted, and a known liquid crystal cell can be used. The first liquid crystal cell typically has a plurality of regions where the alignment direction of the liquid crystal compound can be controlled, and independently controls the alignment direction of the liquid crystal compound in each region to adjust the amount of light transmitted through the region of the liquid crystal panel corresponding to each region.

A type of the first liquid crystal cell is not particularly limited, and a known type can be used. Examples of the type of the first liquid crystal cell include an in-plane switching (IPS) type liquid crystal cell, a vertical alignment (VA) type liquid crystal cell, and an optically compensated bend (OCB) type liquid crystal cell, in addition to the above-described TN type liquid crystal cell.

In addition, the first liquid crystal cell may be a super twisted nematic (STN) type liquid crystal cell having a twist angle of 180° or more, or a vertically aligned twisted nematic (VATN) type liquid crystal cell in which rod-like liquid crystal molecules are substantially vertically aligned in a state in which no voltage is applied and the liquid crystal layer is twisted and aligned at 60° to 120° in a state in which a voltage is applied, which is described in JP1998-123576A (JP-H10-123576A).

Among these, the first liquid crystal cell is preferably selected from the group consisting of the TN type liquid crystal cell, the IPS type liquid crystal cell, and the VA type liquid crystal cell.

In the TN type liquid crystal cell, the rod-like liquid crystal molecules are substantially horizontally aligned in a case where no voltage is applied, and further twisted and aligned at 60° to 120° along the thickness direction. The TN type liquid crystal cell is most likely used as a color thin film transistor (TFT) liquid crystal display device, and is described in many documents.

In the VA type liquid crystal cell, the rod-like liquid crystal molecules are substantially vertically aligned in a case where no voltage is applied. The concept of the VA type liquid crystal cell includes (1) a VA type liquid crystal cell in a narrow sense where rod-like liquid crystalline molecules are aligned substantially vertically at the time of no voltage application and substantially horizontally at the time of voltage application (described in JP1990-176625A (JP-H2-176625A)), (2) a (MVA type) liquid crystal cell (SID97, described in Digest of tech. Papers (proceedings) 28 (1997) 845) in which the VA type is formed to have multi-domain in order to expand the viewing angle, (3) a (n-ASM type) liquid crystal cell in a type in which rod-like liquid crystalline molecules are substantially vertically aligned at the time of no voltage application and twistedly multi-domain aligned at the time of voltage application (described in proceedings of Japanese Liquid Crystal Conference, pp. 58 to 59 (1998)), and (4) a SURVIVAL type liquid crystal cell (presented at LCD International 98). The VA type liquid crystal cell may be any one of a patterned vertical alignment (PVA) type, an optical alignment type, or a polymer-sustained alignment (PSA) type. Details of these types are described in JP2006-215326A and JP2008-538819A.

In the IPS type liquid crystal cell, the rod-like liquid crystal molecules are substantially aligned parallel to a substrate, and a voltage is applied between electrodes to generate an electric field parallel to a surface of the substrate, so that the liquid crystal molecules respond planarly. In the IPS type liquid crystal cell, black display is exhibited in a state in which no voltage is applied, and absorption axes of a pair of upper and lower polarizing plates are orthogonal to each other. A method of reducing leakage light during the black display in an oblique direction and improve the viewing angle using the optical compensation sheet is described in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), JP1998-307291A (JP-H10-307291A), and the like.

### [Second Polarizer]

The second polarizer included in the laminate according to the embodiment of the present invention is not particularly limited, and a known polarizer (linear polarizer) can be used.

The absorption axis of the second polarizer is orthogonal to the absorption axis of the first polarizer described above.

Examples and preferred aspects of the second polarizer are the same as those of the first polarizer, and thus the description thereof will not be repeated.

### [Second Liquid Crystal Cell]

The second liquid crystal cell included in the laminate according to the embodiment of the present invention is disposed between the second polarizer and the second light absorption anisotropic layer, and controls the polarization state of the polarized light transmitted through the second liquid crystal cell.

The second liquid crystal cell is not particularly limited as long as the polarization state of the polarized light transmitted through the second liquid crystal cell can be controlled, and a known liquid crystal cell can be used.

The second liquid crystal cell may have a plurality of regions where the alignment direction of the liquid crystal compound can be controlled, and in this case, the alignment direction of the liquid crystal compound in each region can be independently controlled, and the polarization state of the polarized light transmitted through each region can be adjusted. In a case where the second liquid crystal cell has a plurality of regions where the alignment direction of the liquid crystal compound can be controlled, it is also possible to control the alignment direction of the liquid crystal compound only in the specific region. Therefore, it is possible to switch between shielding and emitting light emitted from the region of the liquid crystal display device corresponding to the above-described specific region.

The second liquid crystal cell may have a single region where the alignment direction of the liquid crystal compound can be controlled, instead of having the plurality of regions as described above.

A type of the second liquid crystal cell is not particularly limited, and a known type can be used. As the type of the second liquid crystal cell, the types described for the first liquid crystal cell can be used in addition to the above-described TN type liquid crystal cell.

Among these, the second liquid crystal cell is preferably selected from the group consisting of the TN type liquid crystal cell, the IPS type liquid crystal cell, and the VA type liquid crystal cell.

Here, in a case where the second liquid crystal cell is a liquid crystal cell capable of switching an in-plane phase difference of the second liquid crystal cell between 0 and λ/2, in a state in which the in-plane phase difference of the second liquid crystal cell is λ/2, it is preferable that an angle between an in-plane slow axis direction of the second liquid crystal cell and the absorption axis of the second polarizer is in a range of 45°±10°.

Examples of the liquid crystal cell capable of switching the in-plane phase difference between 0 and λ/2 include the VA type liquid crystal cell.

The fact that the in-plane phase difference is λ/2 does not strictly require that the in-plane phase difference is λ/2, and the in-plane phase difference at a wavelength of 550 nm is preferably 235 to 315 nm and more preferably 255 to 295 nm.

Hereinafter, in the aspects shown in FIGS. 2 and 3, a modification example in which the second liquid crystal cell 200 is changed from the TN type liquid crystal cell to the VA type liquid crystal cell in which the in-plane phase difference can be switched between 0 and λ/2 will be described. Even in such a modification example, the light emitted in the second viewing direction 3 of FIG. 3 can be switched between light shielding and emission, depending on whether or not a voltage is applied to the second liquid crystal cell.

In general, in the VA type liquid crystal cell, in a state in which no voltage is applied, the liquid crystal compound is aligned in a thickness direction of the liquid crystal cell. On the other hand, in a case where a voltage is applied to the liquid crystal cell, the liquid crystal compound is aligned in an in-plane direction of the liquid crystal cell to cause an in-plane phase difference.

In a state in which the in-plane phase difference of the second liquid crystal cell in the modification example is λ/2, in a case where an angle formed between the in-plane slow axis direction of the second liquid crystal cell and the absorption axis of the second polarizer is in a range of 45°±10°, linearly polarized light components in the first viewing direction 2 and the second viewing direction 3 in FIGS. 2 and 3 are converted into polarized light components in a direction orthogonal to each other, as in the state in which a voltage is applied to the second liquid crystal cell 200 in the aspects shown in FIGS. 2 and 3. On the other hand, in a state in which the in-plane phase difference of the second liquid crystal cell in the modification example is 0, the polarization state of the polarized light component transmitted through the liquid crystal cell is maintained as in the state in which no voltage is applied to the second liquid crystal cell 200 in the aspects shown in FIGS. 2 and 3.

Therefore, even in a case where the VA type liquid crystal cell is used as the second liquid crystal cell, as in the aspects shown in FIGS. 2 and 3 described above, the light emitted in the second viewing direction 3 of FIG. 3 can be switched between light shielding and emission, depending on whether or not a voltage is applied to the second liquid crystal cell.

In addition, the second liquid crystal cell may be a liquid crystal cell in which an in-plane phase difference of the second liquid crystal cell is λ/2 and a direction of an in-plane slow axis can be changed in an in-plane direction. Examples of such a liquid crystal cell include the IPS type liquid crystal cell.

Hereinafter, in the aspects shown in FIGS. 2 and 3, a modification example in which the second liquid crystal cell 200 is changed from the TN type liquid crystal cell to the IPS type liquid crystal cell in which the in-plane phase difference is λ/2 and the direction of the in-plane slow axis can be changed in the in-plane direction will be described. The fact that the in-plane phase difference is λ/2 does not strictly require that the in-plane phase difference is λ/2, and the in-plane phase difference at a wavelength of 550 nm is preferably 235 to 315 nm and more preferably 255 to 295 nm.

Even in such a modification example, the light emitted in the second viewing direction 3 of FIG. 3 can be switched between light shielding and emission, depending on whether or not a voltage is applied to the second liquid crystal cell and the degree thereof.

In general, in the IPS type liquid crystal cell, the alignment direction of the liquid crystal compound is controlled depending on whether or not a voltage is applied and the degree thereof. In a case where the alignment direction of the liquid crystal compound is controlled, the direction of the in-plane slow axis in the liquid crystal cell changes.

In a case where the in-plane phase difference of the second liquid crystal cell in the modification example is λ/2 and an angle formed between the in-plane slow axis of the second liquid crystal cell and the absorption axis of the second polarizer is in a range of 45°±10°, linearly polarized light components in the first viewing direction 2 and the second viewing direction 3 in FIGS. 2 and 3 are converted into polarized light components in a direction orthogonal to each other, as in the state in which a voltage is applied to the second liquid crystal cell 200 in the aspects shown in FIGS. 2 and 3. On the other hand, in a case where the angle between the in-plane slow axis of the second liquid crystal cell in the modification example and the absorption axis of the second polarizer is in a range of 0°±10°, the polarization state is maintained without substantially performing the polarization conversion of the linearly polarized light components in the first viewing direction 2 and the second viewing direction 3 of FIGS. 2 and 3.

Therefore, even in a case where the IPS type liquid crystal cell is used as the second liquid crystal cell, as in the aspects shown in FIGS. 2 and 3 described above, the light emitted in the second viewing direction 3 of FIG. 3 can be switched between light shielding and emission, depending on whether or not a voltage is applied to the second liquid crystal cell.

### [Second Light Absorption Anisotropic Layer]

The second light absorption anisotropic layer in the laminate according to the embodiment of the present invention contains a dichroic substance, and the angle θ2 between the transmittance central axis of the second light absorption anisotropic layer and the normal direction of the surface of the second light absorption anisotropic layer is 0° to 45°. The transmittance central axis usually coincide with an alignment direction of the dichroic substance.

As described above, the above-described angle θ2 can be adjusted according to the direction in which the image is desired to be visually recognized. For example, in a case where a function of preventing unauthorized viewing is imparted to the liquid crystal display device, it is preferable to maximize a transmittance in the front direction. In this case, the above-described angle θ2 is preferably 0° to 10°.

In addition, the transmittance central axis of the light absorption anisotropic layer may be set to different directions depending on a location of the second light absorption anisotropic layer in a plane. For example, in an in-vehicle display in which a display surface is a curved surface, in order to prevent emitted light from any position from being reflected from the windshield or the like and to allow the driver to appropriately recognize the display image, it is preferable to adjust the direction of the transmittance central axis of the second light absorption anisotropic layer to match the curved surface.

A method of measuring the angle θ2 is the same as the method of measuring the angle θ1 described above.

Examples and preferred aspects of the dichroic coloring agent and the liquid crystal compound, contained in the second light absorption anisotropic layer, are the same as the aspects of the first light absorption anisotropic layer, and thus the description thereof will not be repeated.

In addition, the second light absorption anisotropic layer may include a layer other than the layer containing the dichroic substance, and the description thereof will not be repeated since the layer is the same as the layer which may be included in the first light absorption anisotropic layer.

### [Other Layers]

The laminate according to the embodiment of the present invention may include a layer (other layers) other than the above-described configurations.

Examples of the other layers include an optical compensation film, a protective film, a pressure-sensitive adhesive layer, an adhesive layer, a diffusion sheet, a prism sheet, and a reflective sheet. As the other layers, known layers can be adopted.

Among these, the laminate according to the embodiment of the present invention preferably includes an optical compensation film. Examples of the optical compensation film include a retardation layer, and more specific examples thereof an A-plate, a B-plate, and a C-plate. The optical compensation film can be appropriately selected according to the characteristics of the first light absorption anisotropic layer, the second light absorption anisotropic layer, the first liquid crystal cell, and the second liquid crystal cell.

The A-plate consists of two kinds of a positive A-plate (A-plate having a positive value; +A-plate) and a negative A-plate (A-plate having a negative value; −A-plate). In a case where a refractive index in an in-plane slow axis direction of a film is represented by nx, a refractive index in a direction orthogonal to the in-plane slow axis in the plane is represented by ny, and a refractive index in a thickness direction is represented by nz, the positive A-plate satisfies a relationship represented by Expression (A1), and the negative A-plate satisfies a relationship represented by Expression (A2). The positive A-plate has an Rth showing a positive value and the negative A-plate has an Rth showing a negative value. The in-plane slow axis direction of the film is a direction in which the in-plane refractive index is the maximum.

$$nx > ny \approx nz \qquad Expression ( A1 )$$

$$ny < nx \approx nz \qquad Expression ( A2 )$$

The symbol “≈” encompasses not only a case where both sides are completely the same as each other but also a case where the both sides are substantially the same as each other. The expression “substantially the same” means that, for example, a case where (ny−nz)×d is −10 to 10 nm and preferably −5 to 5 nm is also included in “ny≈nz”; and a case where (nx−nz)×d is −10 to 10 nm and preferably −5 to 5 nm is also included in “nx≈nz”. In (ny−nz)×d, d represents a thickness of the film.

The B-plate is a plate in which all values of nx, ny, and nz are different from each other, and consists of two kinds of a negative B-plate which has an Rth showing a negative value and satisfies a relationship represented by Expression (B1) and a positive B-plate has an Rth showing a positive value and satisfies a relationship represented by Expression (B2).

$$( nx + ny ) / 2 > nz \qquad Expression ( B1 )$$

$$( nx + ny ) / 2 < nz \qquad Expression ( B2 )$$

An Nz coefficient of the B-plate is preferably 1.5 or more, more preferably 2.0 to 10.0, and still more preferably 3.0 to 5.0. The Nz coefficient means a value represented by Nz=(nx−nz)/(nx−ny).

The C-plate consists of two kinds of a positive C-plate (C-plate having a positive value; +C-plate) and a negative C-plate (C-plate having a negative value; −C-plate). The positive C-plate satisfies a relationship represented by Expression (C1) and the negative C-plate satisfies a relationship represented by Expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where the both sides are substantially the same as each other. The expression “substantially the same” means that, for example, a case where (nx−ny)×d is 0 to 10 nm and preferably 0 to 5 nm is also included in “nx≈ny”. In (ny−nz)×d, d represents a thickness of the film.

As the optical compensation film, the B-plate is preferably used. Among these, it is preferable that the B-plate is disposed between the first light absorption anisotropic layer and the first polarizer, and it is more preferable that the B-plate is disposed such that an angle between the absorption axis of the first polarizer and the in-plane slow axis of the B-plate is 0°±10°.

### <Liquid Crystal Display Device>

The liquid crystal display device according to the embodiment of the present invention includes the laminate according to the embodiment of the present invention.

The liquid crystal display device is not particularly limited, and examples thereof include a device. The liquid crystal display device may be used as, for example, a liquid crystal display, a head-up display, a head-mounted display, or the like.

The liquid crystal display device according to the embodiment of the present invention may be used in combination with a configuration which is typically used in this field. For example, the liquid crystal display device according to the embodiment of the present invention may be combined with a protective film, an optical compensation film, or the like.

As shown in FIGS. 1 and 2, the liquid crystal display device according to the embodiment of the present invention includes the laminate 10 and the plane light source 400. A backlight which is typically used in a liquid crystal display device can be adopted to the plane light source 400. As a light source of the backlight, for example, a cold cathode lamp, a light emitting diode (LED), or the like can be used. In addition, external light may be used as the plane light source 400.

As described above, in the liquid crystal display device according to the embodiment of the present invention, the light emitted in the front viewing direction 1 of FIG. 1 is emitted from the liquid crystal display device, and the light emitted in the first viewing direction 2 is shielded regardless of whether or not a voltage is applied to the second liquid crystal cell 200. In addition, the light emitted in the second viewing direction 3 of FIG. 2 can be switched between light shielding and emission, depending on whether or not a voltage is applied to the second liquid crystal cell 200.

The liquid crystal display device according to the embodiment of the present invention can be adopted to a display capable of adjusting a viewing angle in a direction orthogonal to a specific direction, while narrowing the viewing angle in a specific direction. That is, the liquid crystal display device according to the embodiment of the present invention can be adopted to a viewing angle control system.

### <In-Vehicle Display>

The in-vehicle display according to the embodiment of the present invention includes the above-described liquid crystal display device according to the embodiment of the present invention.

In a case where the liquid crystal display device according to the embodiment of the present invention is adopted to an in-vehicle display, the light emitted in the front viewing direction 1 in FIG. 1 is emitted from the liquid crystal display device and can be visually recognized by, for example, a passenger other than a driver. Since the light emitted in the first viewing direction 2 is always shielded, the image displayed on the windshield or the like is not reflected. In addition, since the light emitted in the second viewing direction 3 of FIG. 2 can be switched between light shielding and emission, the viewing angle of the in-vehicle display in the left-right direction can be controlled. In the in-vehicle display according to the embodiment of the present invention, for example, it is possible to switch whether or not an image to be displayed can be visually recognized in a direction different from the direction of the passenger (for example, a direction of a driver). It is also preferable that the above-described switching is controlled depending on a driving state of the vehicle.

### EXAMPLES

Hereinafter, the present invention will be described in more detail with reference to Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### Example 1

A laminate was obtained by the following procedure, and a liquid crystal display device used in Example 1 was produced.

### [Production of Optical Film 1]

An optical film including a light absorption anisotropic layer was produced by the following procedure.

### (Formation of Alignment Film Layer)

The following composition 1 for forming an alignment film was applied onto a surface of a commercially available cellulose acylate film (manufactured by FUJIFILM Corporation, trade name: FUJITAC TG60UL) using a wire bar. The support on which the coating film was formed was dried with hot air at 140° C. for 120 seconds to form an alignment film AL1, thereby obtaining a cellulose acylate film 1 with an alignment film. A film thickness of the alignment film AL1 was 1 μm.

Composition 1 for forming alignment film

| | | |
|---|---|---|
| Polymer PA-1 shown below | 100.00 | parts by mass |
| Acid generator PAG-1 shown below | 8.25 | parts by mass |
| Stabilizer DIPEA shown below | 0.6 | parts by mass |
| Butyl acetate | 1001.42 | parts by mass |
| Methyl ethyl ketone | 250.36 | parts by mass |

Polymer PA-1 (in the formulae, the numerical value described in each repeating unit denotes the content (% by mass) of each repeating unit with respect to all repeating units)

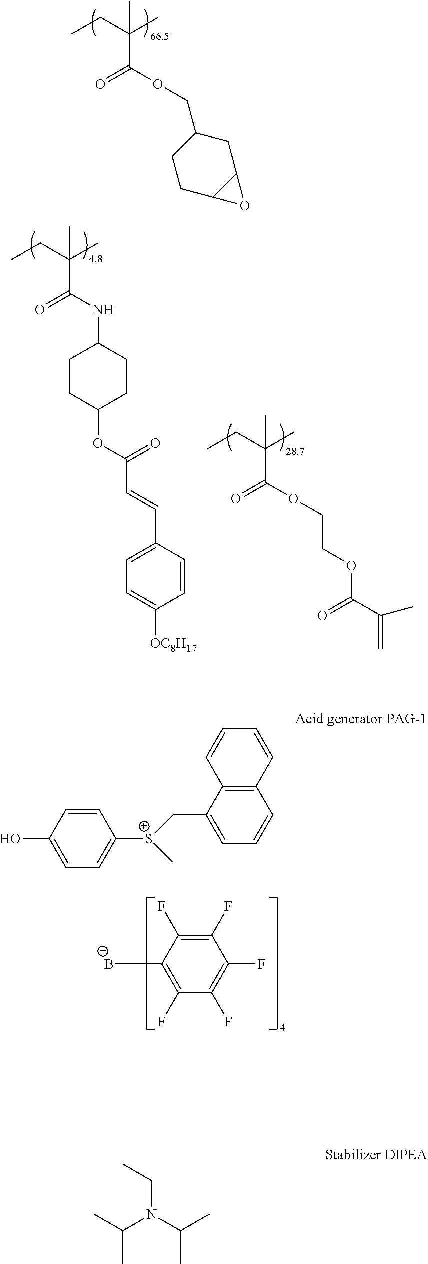

### (Formation of Light Absorption Anisotropic Layer V1)

The obtained cellulose acylate film 1 with an alignment film was continuously coated with the following composition P1 for forming a light absorption anisotropic layer using a wire bar, heated at 120° C. for 60 seconds, and cooled to room temperature (23° C.).

Next, the coating layer was heated at 85° C. for 60 seconds, and then cooled to room temperature again.

Thereafter, the coating layer was irradiated from a normal direction to the film with light for 2 seconds under an irradiation condition of illuminance of 200 mW/cm² using a LED lamp (central wavelength: 365 nm) to produce a light absorption anisotropic layer V1 on the alignment film AL1. A film thickness of the light absorption anisotropic layer V1 was 4.5 μm.

Composition P1 for forming light absorption anisotropic layer

| | |
|---|---|
| Dichroic substance D-1 shown below | 0.69 parts by mass |
| Dichroic substance D-2 shown below | 0.17 parts by mass |
| Dichroic substance D-3 shown below | 1.13 parts by mass |
| Polymer liquid crystal compound P-1 | 8.67 parts by mass |
| shown below | |
| Liquid crystal compound L-1 shown below | 1.97 parts by mass |
| IRGACURE OXE-02 (manufactured | 0.20 parts by mass |
| by BASF SE) | |
| Alignment agent E-1 shown below | 0.16 parts by mass |
| Alignment agent E-2 shown below | 0.16 parts by mass |
| Surfactant F-2 shown below | 0.007 parts by mass |
| Cyclopentanone | 78.17 parts by mass |
| Benzyl alcohol | 8.69 parts by mass |

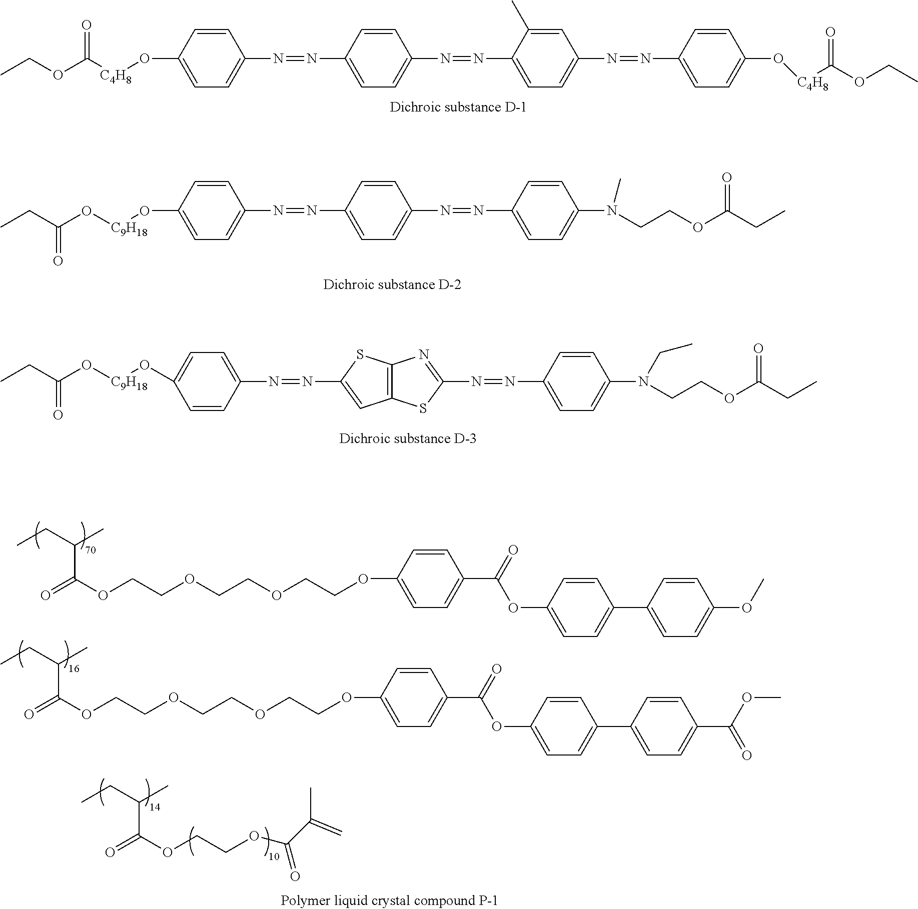

Liquid crystal compound L-1 [mixture of 84:14:2 (mass ratio) of the following liquid crystal compounds (RA), (RB), and (RC)]

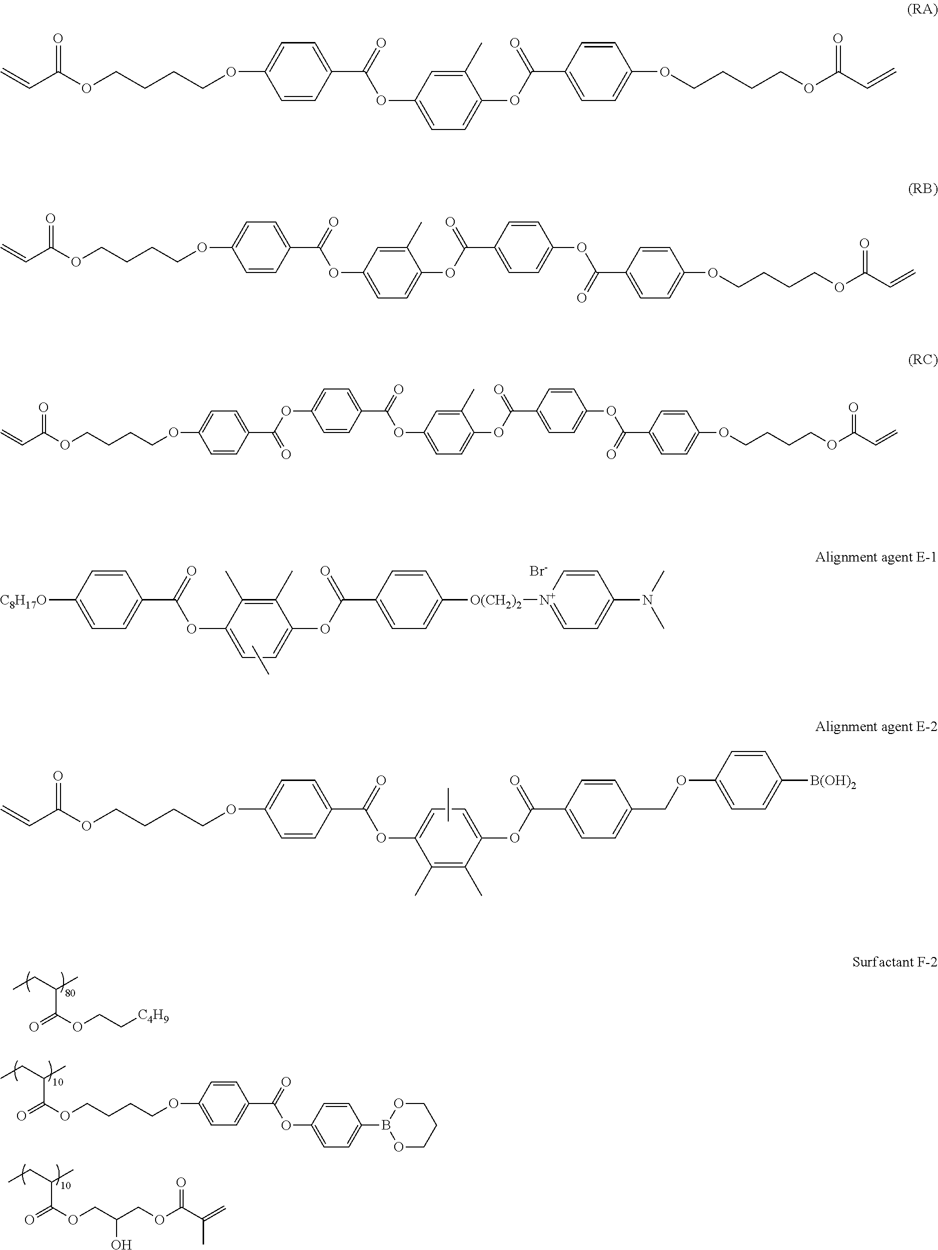

### (Formation of Protective Layer B1)

A coating film was formed by continuously coating the obtained light absorption anisotropic layer V1 with the following composition B1 for forming a protective layer using a wire bar.

Next, the support on which the coating film was formed was dried with hot air at 60° C. for 60 seconds, and further dried with hot air at 100° C. for 120 seconds to form a protective layer B1, thereby producing an optical film 1. A film thickness of the protective layer was 0.5 μm.

In a case where an angle of a transmittance central axis was measured by the above-described method for the produced optical film 1, the angle between the transmittance central axis of the optical film 1 and the normal direction of the surface of the optical film 1 was 0°.

In addition, since all the layer configurations other than the light absorption anisotropic layer V1, included in the optical film 1, had no light absorption anisotropy, the angle of the transmittance central axis calculated above can be read as the value of the light absorption anisotropic layer V1.

In addition, a transmittance of the optical film 1 at a wavelength of 550 nm was measured using AxoScan OPMF-1 (manufactured by Opto Science Inc.). The transmittance of the optical film 1 in the normal direction was 78%, and the transmittance of the optical film 1 in a direction inclined by 30° from the normal direction was 17%.

Composition B1 for forming protective layer

| | |
|---|---|
| Modified polyvinyl alcohol PVA-1 shown above | 3.80 parts by mass |
| IRGACURE 2959 | 0.20 parts by mass |
| Coloring agent compound G-1 shown below | 0.08 parts by mass |
| Water | 70 parts by mass |
| Methanol | 30 parts by mass |

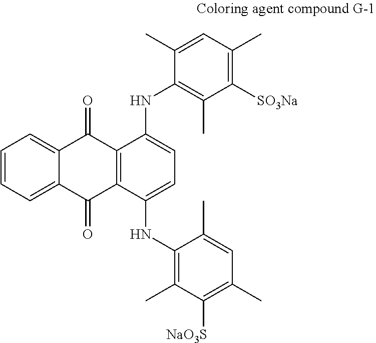

### [Production of TN Type Liquid Crystal Cell]

A horizontal alignment type polyimide alignment film was applied onto two glass substrates with ITO electrodes, dried at a high temperature to form an alignment film, and then subjected to a rubbing treatment.

Thereafter, a thermosetting sealing material was applied onto one of the two glass substrates, and a bead spacer (diameter: 5 μm) was applied onto the other glass substrate, and the two glass substrates were bonded to each other. The two glass substrates were bonded to each other such that surfaces on which the alignment film was formed faced each other and rubbing directions of the alignment films were orthogonal to each other. After bonding, the two glass substrates were vacuum-packed and heated to form an empty cell.

A liquid crystal (MLC-9100 manufactured by Merck Chemicals B. V.) having a positive dielectric anisotropy, a birefringence index Δn of 0.0854 (value at a wavelength of 589 nm and 20° C.), and Δε of approximately +8.5 was injected into the above-described empty cell using a vacuum liquid crystal injector. After injecting the liquid crystal, a TN type liquid crystal cell having Δnd=430 nm was produced by a sealing treatment.

In the TN type liquid crystal cell produced as described above, since the alignment film subjected to the rubbing treatment and the injected liquid crystal were in contact with each other, in a case where a voltage was not applied between the ITO electrodes, the liquid crystal layer was twisted and aligned at a twist angle of 90° between the upper and lower glass substrates. On the other hand, in a case where a voltage was applied between the ITO electrodes, the liquid crystal layer was aligned in the vertical direction.

### [Production of Liquid Crystal Display Device 1]

A liquid crystal display device of dynabook (registered trademark) (manufactured by TOSHIBA CORPORATION), which is a laptop computer equipped with a liquid crystal display device, was disassembled to take out a liquid crystal panel. A liquid crystal display device 1 was produced using the liquid crystal panel, the optical film 1, the TN type liquid crystal cell, and a backlight of Lambertian light distribution, such that the configuration shown in Table 1 was obtained. Each member was bonded using a pressure sensitive adhesive SK2057.

The liquid crystal display device 1 used in Example 1 was produced by bonding the optical film 1, the liquid crystal panel, the TN type liquid crystal cell, the optical film 1, and the backlight in this order from the viewing side. The optical film 1, the liquid crystal panel, the TN type liquid crystal cell, and the laminate obtained by bonding the optical film 1 correspond to the laminate according to the embodiment of the present invention. Here, in the optical film 1, the cellulose acylate film was bonded such that the cellulose acylate film was on the viewing side.

In the above-described liquid crystal panel, the liquid crystal cell (IPS type) was disposed between two polarizers. In addition, absorption axes of the above-described two polarizers were orthogonal to each other.

### Examples 1 to 5 and Comparative Examples 1 to 6

Liquid crystal display devices 2 to 11 were produced in the same manner as in Example 1 so as to have the configuration shown in Table 1. Members which were not used in Example 1 were produced by the methods shown below.

### [Production of VATN Type Liquid Crystal Cell]

First, a vertical alignment type polyimide alignment film was applied onto two glass substrates with ITO electrodes, and dried at a high temperature to form an alignment film. Next, the formed alignment film was subjected to a rubbing treatment.

Thereafter, a thermosetting sealing material was applied onto one of the two glass substrates, and a bead spacer (diameter: 5 μm) was applied onto the other glass substrate, and the two glass substrates were bonded to each other. The two glass substrates were bonded to each other such that surfaces on which the alignment film was formed faced each other and rubbing directions of the alignment films were orthogonal to each other. After bonding, the two glass substrates were vacuum-packed and heated to form an empty cell.

A liquid crystal (MLC-6886 manufactured by Merck Chemicals B.V.) having a negative dielectric anisotropy, a birefringence index Δn of 0.0899 (value at a wavelength of 589 nm and 20° C.), and Δε of approximately −3.6 was injected into the above-described empty cell using a vacuum liquid crystal injector, and then subjected to a sealing treatment to produce a VATN type liquid crystal cell having Δnd=450 nm.

In the VATN type liquid crystal cell produced as described above, since the vertical alignment film and the injected liquid crystal were in contact with each other, in a case where a voltage was not applied between the ITO electrodes, the liquid crystal layer was vertically aligned. On the other hand, in a case where a voltage was applied between the ITO electrodes, since the liquid crystal molecules had a negative dielectric constant anisotropy, a force in a direction parallel to the glass substrates was applied to the liquid crystal molecules, and the liquid crystal molecules were aligned along the rubbing direction of the up-down alignment film. As a result, the liquid crystal molecules were twisted and aligned at a twist angle of 90° between the upper and lower glass substrates.

### [Preparation of IPS Type Liquid Crystal Cell]

An IPS type liquid crystal cell was prepared based on Example 2 of JP2005-351924A. An IPS type liquid crystal cell 1 in which an in-plane phase difference was λ/2 and an IPS type liquid crystal cell 2 in which an in-plane phase difference was λ/4 were prepared.

In a case where the IPS type liquid crystal cell was incorporated into the liquid crystal display device, the liquid crystal alignment direction in the IPS cell in a case where a voltage was not applied was disposed to be parallel to the absorption axis of the polarizer (second polarizer) attached to the backlight side of the liquid crystal panel, and the direction was set to be 45° with respect to the absorption axis of the second polarizer in a case where a voltage was applied.

### [Preparation of PDLC Cell]

A polymer dispersed liquid crystal (PDLC) cell was prepared based on Example 1 of WO2021/200828A.

### [Organic EL Panel]

iPhone (registered trademark) 12 manufactured by Apple Inc., equipped with an organic EL panel (organic EL display device), was disassembled to take out an organic EL panel.

### [Louver Film]

A security/privacy filter (PF12.1W9H2) manufactured by 3M was used.

[Production of λ/4 plate]

### (Preparation of Composition for Forming Photo-Alignment Film)

### —Synthesis of Polymer E-2—

100.0 parts by mass of 2-(3,4-epoxycyclohexyl)ethyltrimethoxysilane, 500 parts by mass of methyl isobutyl ketone, and 10.0 parts by mass of triethylamine were charged into a reaction container provided with a stirrer, a thermometer, a dropping funnel, and a reflux condenser, and the mixture was stirred at room temperature. Next, 100 parts by mass of deionized water was added dropwise to the obtained mixture from the dropping funnel over 30 minutes, and then the mixture was reacted at 80° C. for 6 hours while mixing the mixture under reflux. After completion of the reaction, an organic phase was extracted from the mixture, and washed with an aqueous solution of 0.2% by mass ammonium nitrate until water used in the washing was neutral. Thereafter, the solvent and the water were distilled off from the obtained organic phase under reduced pressure to obtain a polyorganosiloxane having an epoxy group as a viscous transparent liquid.

The polyorganosiloxane having an epoxy group was subjected to ¹H-NUCLEAR MAGNETIC RESONACE (NMR) analysis, and it was confirmed that peaks based on an oxiranyl group around a chemical shift (Δ)=3.2 ppm were obtained as per theoretical strength, and a side reaction of the epoxy group did not occur during the reaction. A weight-average molecular weight Mw of the polyorganosiloxane having an epoxy group was 2,200, and an epoxy equivalent was 186 g/mol.

Next, 10.1 parts by mass of the polyorganosiloxane having an epoxy group obtained above, 0.5 parts by mass of an acryloyl group-containing carboxylic acid (manufactured by Toagosei Co., Ltd., trade name “ARONIX M-5300”, ω-carboxypolycaprolactone acrylate (degree of polymerization: n≈2)), 20 parts by mass of butyl acetate, 1.5 parts by mass of a cinnamic acid derivative obtained by a method of Synthesis Example 1 of JP2015-26050A, and 0.3 parts by mass of tetrabutylammonium bromide were charged into a 100 ml three-neck flask, and the obtained mixture was stirred at 90° C. for 12 hours. After the stirring, the mixture was diluted with butyl acetate in the same amount (mass) as that of the obtained mixture, and the diluted mixture was washed with water three times. An operation in which the obtained mixture was concentrated and diluted using butyl acetate was repeated twice to finally obtain a solution containing a polyorganosiloxane (the following polymer E-2) having a photo-aligned group. A weight-average molecular weight Mw of the polymer E-2 was 9,000. In addition, as a result of ¹H-NMR analysis, the amount of the component having a cinnamate group in the polymer E-2 was 23.7% by mass.

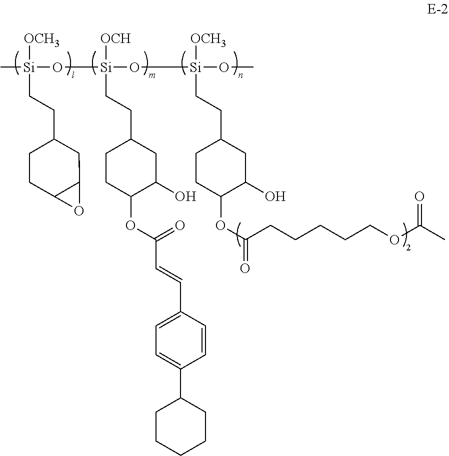

### —Preparation of Composition for Forming Photo-Alignment Film—

The following components were mixed to prepare a composition for forming a photo-alignment film.

Composition for forming photo-alignment film

| | | |
|---|---|---|
| Polymer E-2 described above | 10.67 | parts by mass |
| Low-molecular-weight compound | 5.17 | parts by mass |
| R-1 shown below | | |
| Additive (B-1) shown below | 0.53 | parts by mass |
| Butyl acetate | 8287.37 | parts by mass |
| Propylene glycol monomethyl | 2071.85 | parts by mass |
| ether acetate | | |

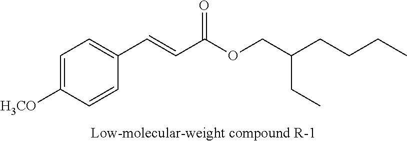 [SMILES: CCCCC(CC)COC(=O)/C=C/c1ccc(OC)cc1]

Additive (B-1): TA-60B manufactured by San-Apro Limited (refer to the following structural formula)

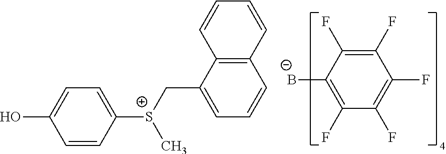

### (Preparation of Coating Liquid for Optically Anisotropic Layer

A coating liquid for an optically anisotropic layer, having the following formulation, was prepared.

Coating liquid for optically anisotropic layer

| | | |
|---|---|---|
| Liquid crystal compound L-3 shown below | 42.00 | parts by mass |
| Liquid crystal compound L-4 shown below | 42.00 | parts by mass |
| Polymerizable compound A-1 shown below | 16.00 | parts by mass |
| Low-molecular-weight compound B2 | 6.00 | parts by mass |
| shown below | | |
| Polymerization initiator S-1 | 0.50 | parts by mass |
| (oxime type) shown below | | |
| Leveling agent G-1 shown below | 0.20 | parts by mass |
| HISOLVE MTEM (manufactured by TOHO | 2.00 | parts by mass |
| Chemical Industry Co., Ltd.) | | |
| NK Ester A-200 (manufactured by | 1.00 | part by mass |
| Shin-Nakamura Chemical Co., Ltd.) | | |
| Methyl ethyl ketone | 424.8 | parts by mass |

A group adjacent to the acryloyloxy group of the following liquid crystal compounds L-3 and L-4 represents a propylene group (group in which a methyl group was substituted with an ethylene group). Each of the following liquid crystal compounds L-3 and L-4 represents a mixture of regioisomers with different methyl group positions.

The numerical value in the repeating unit in the leveling agent G-1 represents % by mole of each repeating unit with respect to all the repeating units in the leveling agent G-1.

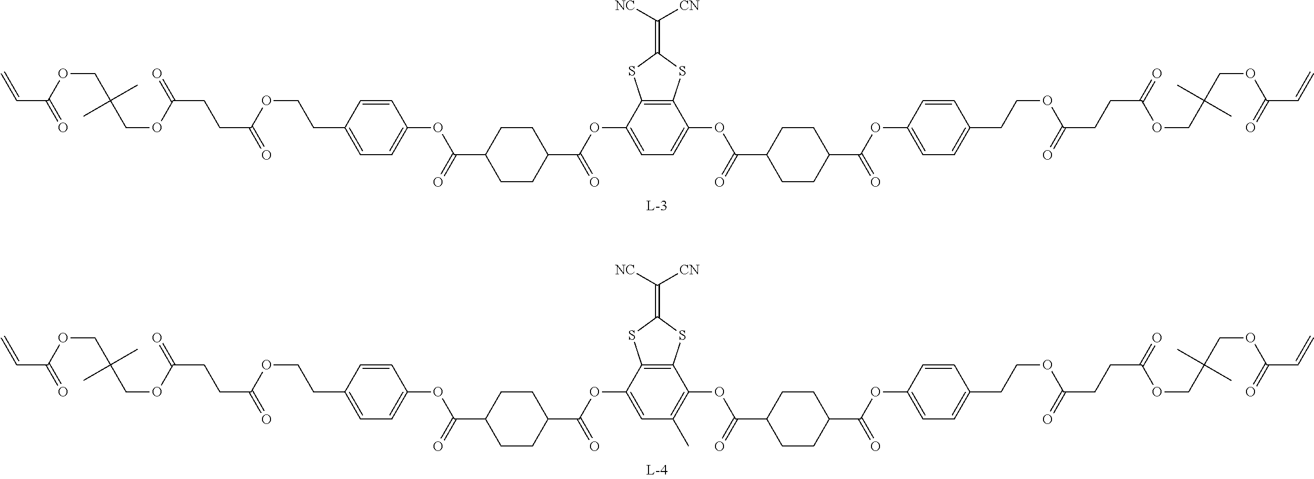

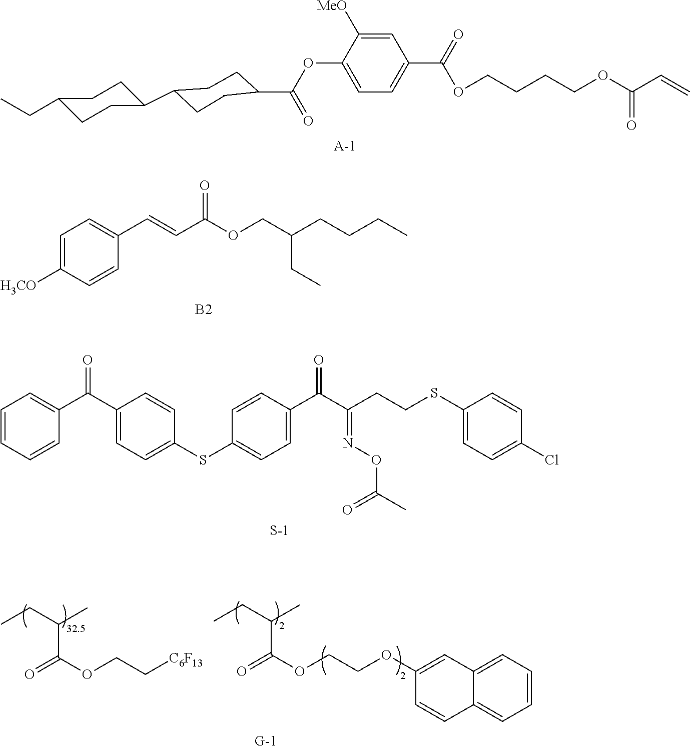

### (Production of Cellulose Acylate Film 1)

### —Production of Core Layer Cellulose Acylate Dope—

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl | 100 parts by mass |
| substitution degree of 2.88 | |
| Polyester compound B described in | 12 parts by mass |
| Examples of JP2015-227955A | |
| Compound F shown below | 2 parts by mass |
| Methylene chloride (first solvent) | 430 parts by mass |
| Methanol (second solvent) | 64 parts by mass |

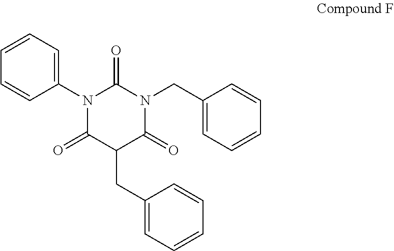 [SMILES: O=C1C(Cc2ccccc2)C(=O)N(c2ccccc2)C(=O)N1Cc1ccccc1]

### —Production of Outer Layer Cellulose Acylate Dope—

10 parts by mass of the following matting agent solution was added to 90 parts by mass of the above-described core layer cellulose acylate dope to prepare a cellulose acetate solution used as an outer layer cellulose acylate dope.

Matting agent solution

| | | |
|---|---|---|
| Silica particles having an average particle | 2 | parts by mass |
| diameter of 20 nm (AEROSIL R972, manufactured | | |
| by Nippon Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### (Production of Cellulose Acylate Film 1)

The core layer cellulose acylate dope and the outer layer cellulose acylate dope were filtered through filter paper having an average hole diameter of 34 mm and a sintered metal filter having an average pore size of 10 mm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Subsequently, the film was peeled off from the drum immediately before a timing when a content of the solvent of the film on the drum reached approximately 20% by mass, both end parts of the film in the width direction were fixed with tenter clips, and the film was dried while being stretched at a stretching ratio of 1.1 times in the horizontal direction.

Thereafter, the film was transported between rolls in a heating treatment device, and further dried to produce an optical film having a thickness of 40 mm, which was regarded as a cellulose acylate film 1. An in-plane retardation of the obtained cellulose acylate film 1 was 0 nm.

The composition for forming a photo-alignment film prepared in advance was applied onto a surface of one side of the produced cellulose acylate film 1 using a bar coater.

After the coating, the film was dried on a hot plate at 120° C. for 1 minute to remove the solvent, thereby forming a composition layer for forming a photo-alignment film, having a thickness of 0.3 mm.

The obtained composition layer for forming a photo-alignment film was irradiated with polarized ultraviolet rays (10 mJ/cm², using an ultra-high-pressure mercury lamp) to form a photo-alignment film.

Next, the coating liquid for an optically anisotropic layer prepared in advance was applied onto the photo-alignment film using a bar coater to form a composition layer.

The formed composition layer was once heated to 110° C. on a hot plate and cooled to 60° C. so that the alignment was stabilized.

Thereafter, while keeping the temperature at 60° C., the alignment was fixed by irradiation with ultraviolet rays (500 mJ/cm², using an ultra-high pressure mercury lamp) in a nitrogen atmosphere (oxygen concentration: 100 ppm) to form an optically anisotropic layer having a thickness of 2.3 mm, thereby producing a λ/4 plate 1 (λ/4 phase difference film 1). An in-plane retardation of the obtained λ/4 plate 1 at a wavelength of 550 nm was 140 nm.

### [Production of B-Plate]

### (Extrusion Molding)

A cycloolefin resin ARTON G7810 (manufactured by JSR Corporation) was dried at 100° C. for 2 hours or more, and melt-extruded at 280° C. using a twin screw kneading extruder. Here, a screen filter, a gear pump, and a leaf disc filter were arranged in this order between the extruder and a die, these were connected by a melt pipe, and the resultant was extruded from a T die having a width of 1000 mm and a lip gap of 1 mm and was cast on a triple cast roll in which temperatures were set to 180° C., 175° C., and 170° C., thereby obtaining an un-stretched film 1 having a width of 900 mm and a thickness of 320 μm.

### (Stretching and Thermal Fixation)

The un-stretched film 1 transported was subjected to a stretching step and a thermal fixing step by the following method.

### (a) Machine-Directional Stretching

The un-stretched film 1 was machine-directionally stretched under the following conditions while being transported using an inter-roll machine-direction stretching machine having an aspect ratio (L/W) of 0.2.

### <Conditions>

Preheating temperature: 170° C.
Stretching temperature: 170° C.
Stretching ratio: 155%

### (b) Cross-Direction Stretching

The machine-directionally stretched film was cross-directionally stretched under the following conditions while being transported using a tenter.

### <Conditions>

Preheating temperature: 170° C.
Stretching temperature: 170° C.
Stretching ratio: 80%

### (c) Thermal Fixation

After the stretching step, the stretched film was subjected to a heat treatment under the following conditions while end portions of the stretched film were gripped with a tenter clip to hold both end portions of the stretched film such that the width thereof was constant (within 3% of expansion or contraction), and the stretched film was thermally fixed.
Thermal fixation temperature: 165° C.
Thermal fixation time: 30 seconds

The preheating temperature, the stretching temperature, and the thermal fixation temperature are average values of values measured at five points in the width direction using a radiation thermometer.

### (Winding)

After the thermal fixation, both ends of the stretched film were trimmed and wound at a tension of 25 kg/m, thereby obtaining a film roll having a width of 1,340 mm and a winding length of 2,000 m.

With regard to the obtained stretched film, Re was 120 nm, Rth was 420 nm, an Nz coefficient was 4.0, a slow axis was in the MD direction, and a film thickness thereof was 80 μm. The obtained stretched film was regarded as a B-plate 1. In the production of the liquid crystal display device, the slow axis of the B-plate and the absorption axis of the polarizing plate on the liquid crystal panel viewing side were arranged to be parallel to each other.

As described above, the B-plate means a biaxial optical member in which refractive indices nx, ny, and nz are values different from each other, and the Nz coefficient means a value represented by Nz=(nx−nz)/(nx−ny).

### Examples 6 to 9

Liquid crystal display devices 12 to 15 were produced in the same manner as in Example 1, except that the optical film 1 was changed to each of optical films 2 to 5 as shown in Table 1.

### [Production of Optical Film 2]

An optical film 2 having a light absorption anisotropic layer V2 was produced by the same method as that for the optical film 1, except that a composition P2 for forming a light absorption anisotropic layer, having the following formulation, was used instead of the composition P1 for forming a light absorption anisotropic layer.

In a case where an angle of a transmittance central axis was measured by the above-described method for the produced optical film 2, the angle between the transmittance central axis of the optical film 2 and the normal direction of the surface of the optical film 2 was 0°.

In addition, since all the layer configurations other than the light absorption anisotropic layer V2, included in the optical film 2, had no light absorption anisotropy, the angle of the transmittance central axis calculated above can be read as the value of the light absorption anisotropic layer V2.

In addition, a transmittance of the optical film 2 at a wavelength of 550 nm was measured using AxoScan OPMF-1 (manufactured by Opto Science Inc.). The transmittance of the optical film 2 in the normal direction was 69%, and the transmittance of the optical film 2 in a direction inclined by 30° from the normal direction was 15%.

Composition P2 for forming light absorption anisotropic layer

| | |
|---|---|
| Dichroic substance D-4 shown below | 1.82 parts by mass |
| Dichroic substance D-5 shown below | 0.49 parts by mass |
| Dichroic substance D-6 shown below | 3.25 parts by mass |
| Polymer liquid crystal compound | 18.21 parts by mass |
| P-1 shown above | |
| Liquid crystal compound L-1 shown above | 4.13 parts by mass |
| IRGACURE 369 (manufactured by BASF SE) | 1.67 parts by mass |
| Alignment agent E-1 shown above | 0.37 parts by mass |
| Alignment agent E-2 shown above | 0.37 parts by mass |
| Surfactant F-2 shown above | 0.007 parts by mass |
| Cyclopentanone | 62.64 parts by mass |
| Benzyl alcohol | 6.96 parts by mass |

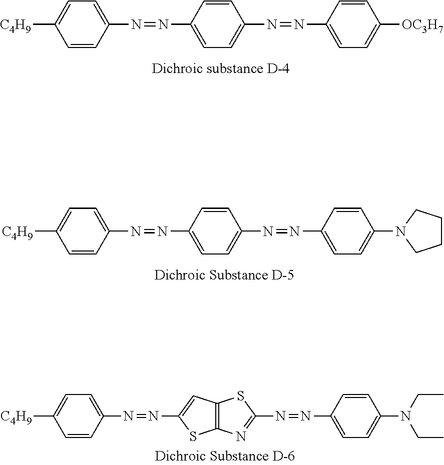

### [Preparation of Optical Film 3]

An optical film 3 having a light absorption anisotropic layer V3 was produced by the same method as that for the optical film 1, except that a composition P3 for forming a light absorption anisotropic layer, having the following formulation, was used instead of the composition P1 for forming a light absorption anisotropic layer.

In a case where an angle of a transmittance central axis was measured by the above-described method for the produced optical film 3, the angle between the transmittance central axis of the optical film 3 and the normal direction of the surface of the optical film 3 was 0°.

In addition, since all the layer configurations other than the light absorption anisotropic layer V3, included in the optical film 3, had no light absorption anisotropy, the angle of the transmittance central axis calculated above can be read as the value of the light absorption anisotropic layer V3 included in the optical film 3.

In addition, a transmittance of the optical film 3 at a wavelength of 550 nm was measured using AxoScan OPMF-1 (manufactured by Opto Science Inc.). The transmittance of the optical film 3 in the normal direction was 70%, and the transmittance of the optical film 3 in a direction inclined by 30° from the normal direction was 15%.

Composition P3 for forming light absorption anisotropic layer

| | |
|---|---|
| Dichroic substance D-1 shown above | 0.79 parts by mass |
| Dichroic substance D-2 shown above | 0.21 parts by mass |
| Dichroic substance D-3 shown above | 1.41 parts by mass |
| Liquid crystal compound L-5 shown below | 7.52 parts by mass |
| Liquid crystal compound L-6 shown below | 2.51 parts by mass |
| IRGACURE 369 (manufactured by BASF SE) | 0.73 parts by mass |
| Surfactant F-2 shown above | 0.007 parts by mass |
| Cyclopentanone | 78.13 parts by mass |
| Benzyl alcohol | 8.67 parts by mass |

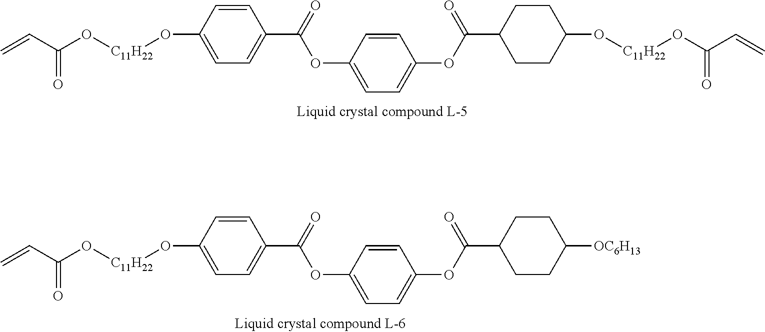

### [Production of Optical Film 4]

An optical film 4 having an light absorption anisotropic layer V4 was produced by the same method as that for the optical film 1, except that a composition P4 for forming a light absorption anisotropic layer, having the following formulation, was used instead of the composition P1 for forming a light absorption anisotropic layer.

In a case where an angle of a transmittance central axis was measured by the above-described method for the produced optical film 4, the angle between the transmittance central axis of the optical film 4 and the normal direction of the surface of the optical film 4 was 0°.

In addition, since all the layer configurations other than the light absorption anisotropic layer V4, included in the optical film 4, had no light absorption anisotropy, the angle of the transmittance central axis calculated above can be read as the value of the light absorption anisotropic layer V4 included in the optical film 4.

In addition, a transmittance of the optical film 4 at a wavelength of 550 nm was measured using AxoScan OPMF-1 (manufactured by Opto Science Inc.). The transmittance of the optical film 4 in the normal direction was 65%, and the transmittance of the optical film 4 in a direction inclined by 30° from the normal direction was 12%.

Composition P4 for forming light absorption anisotropic layer

| | |
|---|---|
| Dichroic substance D-4 shown above | 0.78 parts by mass |
| Dichroic substance D-5 shown above | 0.21 parts by mass |
| Dichroic substance D-6 shown above | 1.39 parts by mass |
| Liquid crystal compound L-5 shown above | 7.39 parts by mass |
| Liquid crystal compound L-6 shown above | 2.46 parts by mass |
| IRGACURE 369 (manufactured by BASF SE) | 0.71 parts by mass |
| BYK-361N (manufactured by | 0.036 parts by mass |
| BYK-Chemie GmbH) | |
| o-Xylene | 87.02 parts by mass |

### [Production of Optical Film 5]

An optical film 5 having a light absorption anisotropic layer V5 was produced by the same method as that for the optical film 1, except that a composition P5 for forming a light absorption anisotropic layer, having the following formulation, was used instead of the composition P1 for forming a light absorption anisotropic layer.

In a case where an angle of a transmittance central axis was measured by the above-described method for the produced optical film 5, the angle between the transmittance central axis of the optical film 5 and the normal direction of the surface of the optical film 5 was 0°.

In addition, since all the layer configurations other than the light absorption anisotropic layer V5, included in the optical film 5, had no light absorption anisotropy, the angle of the transmittance central axis calculated above can be read as the value of the light absorption anisotropic layer V5.

In addition, a transmittance of the optical film 5 at a wavelength of 550 nm was measured using AxoScan OPMF-1 (manufactured by Opto Science Inc.). The transmittance of the optical film 5 in the normal direction was 74%, and the transmittance of the optical film 5 in a direction inclined by 30° from the normal direction was 16%.

Composition P5 for forming light absorption anisotropic layer

| | |
|---|---|
| Dichroic substance D-1 shown above | 0.69 parts by mass |
| Dichroic substance D-2 shown above | 0.17 parts by mass |
| Dichroic substance D-3 shown above | 1.13 parts by mass |
| Polymer liquid crystal compound | 8.67 parts by mass |
| P-1 shown above | |
| Liquid crystal compound L-5 shown above | 1.48 parts by mass |
| Liquid crystal compound L-6 shown below | 0.49 parts by mass |
| IRGACURE OXE-02 (manufactured | 0.20 parts by mass |
| by BASF SE) | |
| Alignment agent E-1 shown above | 0.16 parts by mass |
| Alignment agent E-2 shown above | 0.16 parts by mass |
| Surfactant F-2 shown above | 0.007 parts by mass |
| Cyclopentanone | 78.17 parts by mass |
| Benzyl alcohol | 8.69 parts by mass |

### <Evaluation>

### [Evaluation of Viewing Angle Controllability in Left-Right Direction and Constant Light Shielding Properties in Up-Down Direction of Liquid Crystal Display Device]

In each of the produced liquid crystal display devices, ability to switch between light shielding and transmission in the left-right direction by controlling the voltage applied to the liquid crystal cell or to the PDLC cell was evaluated. That is, it was evaluated whether or not each liquid crystal display device had viewing angle controllability in the left-right direction.

In addition, whether or not light emitted in the up-down direction orthogonal to the left-right direction was shielded was evaluated regardless of the control of the voltage.

Here, the left-right direction means a direction parallel to the absorption axis of the polarizing plate on the viewing side of the liquid crystal panel, and the direction was set as a direction from an azimuthal angle of 0° to 180°. In addition, the up-down direction means a direction perpendicular to the absorption axis of the polarizing plate on the viewing side of the liquid crystal panel, and the direction was set as a direction from an azimuthal angle of 90° to 270°.

For example, the fact that light is shielded in the left direction refers to that a ratio of a brightness in a direction of an azimuthal angle of 0° and a polar angle of 30° to a brightness at a polar angle of 0° (direction perpendicular to the surface of the liquid crystal display device) is 0.5 or less. The fact that light is shielded in the right direction, the upward direction, or the downward direction also refers to that a ratio of a brightness at a polar angle of 30° to a brightness at a polar angle of 0° is 0.5 or less.

Here, the method of measuring the brightness is the same as the measuring method in “Evaluation of light shielding properties in oblique direction during viewing angle control” described later.

[Evaluation of light shielding properties in oblique direction during viewing angle control]

Using the produced liquid crystal display device and a measuring instrument “EZ-Contrast XL88” (manufactured by ELDIM), the brightness was measured from an azimuthal angle of 0° to 360° in increments of 15° in a counterclockwise direction and from a polar angle of 0° (front direction) to 80° in increments of 5°. In this case, in a state in which the viewing angle in the left-right direction was controlled, a ratio of the brightness in the left-right direction (azimuthal angle of 0° and polar angle of 30°, and azimuthal angle of 180° and polar angle of) 30° to a brightness in the front direction (polar angle of) 0°, and a ratio of the brightness in the up-down direction (azimuthal angle of 90° and polar angle of 30°, and azimuthal angle of 270° and polar angle of) 30° to the brightness in the front direction (polar angle of) 0° were obtained, and light shielding properties in the oblique direction during the viewing angle control were evaluated based on the following standard.

Practically, the evaluation of the light shielding properties in the oblique direction during the viewing angle control is preferably B or A.

An average value of the brightness at the azimuthal angle of 0° and the polar angle of 30° and the brightness at the azimuthal angle of 180° and the polar angle of 30° was adopted as the brightness in the left-right direction. In addition, an average value of the brightness at the azimuthal angle of 90° and the polar angle of 30° and the brightness at the azimuthal angle of 270° and the polar angle of 30° was adopted as the brightness in the up-down direction.
A: 0.2 or less in both the up-down direction and the left-right direction
B: 0.3 or less in both the up-down direction and the left-right direction, and at least one direction was more than 0.2
C: any one of the up-down direction or the left-right direction was more than 0.3

### [Evaluation of Light Resistance]

The produced liquid crystal display device was irradiated with xenon lamp light from the front direction for 150 hours using a Super Xenon Weather Meter SX75 manufactured by Suga Test Instruments Co., Ltd.

Before and after the irradiation, the brightness in the left-right direction (azimuthal angle of 0° and polar angle of 30°, and azimuthal angle of 180° and polar angle of) 30° was measured by the same method as described above, a change in brightness before and after the irradiation was calculated, and light resistance was evaluated based on the following standard. The change in brightness (%) was calculated by the following expression.

$$( Change in brightness ) = 100 \times ( ( Brightness before irradiation ) - ( Brightness after irradiation ) ) / ( Brightness before irradiation )$$

An average value of the brightness at the azimuthal angle of 0° and the polar angle of 30° and the brightness at the azimuthal angle of 180° and the polar angle of 30° was adopted as the brightness in the left-right direction.

Practically, the evaluation of the change in brightness is preferably A.
A: change in brightness was less than 2%
B: change in brightness was 2% or more and less than 5%
C: change in brightness was 5% or more

### <Result>

The configurations of the liquid crystal display devices of each of Examples and Comparative Examples and the evaluation results thereof are shown in Table 1 (1-1 and 1-2).

In the column of “Viewing angle controllability (left-right direction)” in Table 1, a case where the viewing angle controllability in the left-right direction was provided is indicated as “A”, and a case where the viewing angle controllability in the left-right direction was not provided is indicated as “B”.

In the column of “Constant light shielding properties (up-down direction)” in Table 1, regardless of whether or not the viewing angle in the left-right direction was controlled, a case where the light was always shielded in the up-down direction is indicated as “A”, and a case where the light was not always shielded in the up-down direction is indicated as “B”.

TABLE 1

| Table 1-1 | Example 1 | Example 2 | Example 3 | Example 4 |
|---|---|---|---|---|
| Liquid crystal | 1 | 2 | 3 | 4 |
| display device | | | | |
| Configuration | | Optical film 1 | | |
| | | Optical film 1 | | |
| | Optical film 1 | Liquid crystal | Optical film 1 | Optical film 1 |
| | | panel | | |
| | Liquid crystal | TN type liquid | Liquid crystal | Liquid crystal |
| | panel | crystal cell | panel | panel |
| | TN type liquid | Optical film 1 | VATN type | IPS type liquid |
| | crystal cell | | liquid crystal | crystal cell 1 |
| | | | cell | |
| | Optical film 1 | Optical film 1 | Optical film 1 | Optical film 1 |
| | Backlight | Backlight | Backlight | Backlight |
| Viewing angle | A | A | A | A |
| controllability | | | | |
| (left-right | | | | |
| direction) | | | | |
| Constant | A | A | A | A |
| light shielding | | | | |
| properties (up-down | | | | |
| direction) | | | | |
| Light shielding | B | A | B | B |
| properties | | | | |
| in oblique | | | | |
| direction during | | | | |
| viewing angle | | | | |
| non-control | | | | |
| Light resistance | B | B | B | B |
| | | Comparative | Comparative | Comparative |
| Table 1-1 | Example 5 | Example 1 | Example 2 | Example 3 |
| Liquid crystal | 5 | 6 | 7 | 8 |
| display device | | | | |
| Configuration | | | | |
| | Optical film 1 | | Optical film 1 | |
| | B-plate 1 | | TN type liquid | |
| | | | crystal cell | |
| | Liquid crystal | Optical film 1 | Optical film 1 | Liquid crystal |
| | panel | | | panel |
| | TN type liquid | IPS type liquid | λ/4 plate1 | PDLC cell |
| | crystal cell | crystal cell 2 | | |
| | Optical film 1 | Liquid crystal | Liquid crystal | Louver film |
| | | panel | panel | |
| | Backlight | Backlight | Backlight | Backlight |
| Viewing angle | A | A | A | A |
| controllability | | | | |
| (left-right | | | | |
| direction) | | | | |
| Constant | A | B | B | B |
| light shielding | | | | |
| properties (up-down | | | | |
| direction) | | | | |
| Light shielding | B | C | C | A |
| properties | | | | |
| in oblique | | | | |
| direction during | | | | |
| viewing angle | | | | |
| non-control | | | | |
| Light resistance | B | B | C | A |

| | Comparative | Comparative | Comparative | | | | |
|---|---|---|---|---|---|---|---|
| Table 1-2 | Example 4 | Example 5 | Example 6 | Example 6 | Example 7 | Example 8 | Example 9 |
| Liquid crystal | 9 | 10 | 11 | 12 | 13 | 14 | 15 |
| display device | | | | | | | |
| Configuration | | | | | | | |
| | Optical film 1 | Liquid crystal | | Optical film 2 | Optical film 3 | Optical film 4 | Optical film 5 |
| | | panel | | | | | |
| | TN type liquid | Optical film 1 | Optical film 1 | Liquid crystal | Liquid crystal | Liquid crystal | Liquid crystal |
| | crystal cell | | | panel | panel | panel | panel |
| | Optical film 1 | TN type liquid | TN type liquid | TN type liquid | TN type liquid | TN type liquid | TN type liquid |
| | | crystal cell | crystal cell | crystal cell | crystal cell | crystal cell | crystal cell |
| | Liquid crystal | Optical film 1 | Optical film 1 | Optical film 2 | Optical film 3 | Optical film 4 | Optical film 5 |
| | panel | | | | | | |
| | Backlight | Backlight | Organic EL | Backlight | Backlight | Backlight | Backlight |
| | | | panel | | | | |
| Viewing angle | A | A | A | A | A | A | A |
| controllability | | | | | | | |
| (left-right | | | | | | | |
| direction) | | | | | | | |
| Constant | A | A | A | A | A | A | A |
| light shielding | | | | | | | |
| properties (up-down | | | | | | | |
| direction) | | | | | | | |
| Light shielding | A | C | A | B | B | B | B |
| properties in | | | | | | | |
| oblique direction | | | | | | | |
| during viewing | | | | | | | |
| angle non-control | | | | | | | |
| Light resistance | C | A | C | B | B | B | B |

From the results shown in Table 1, it was found that the liquid crystal display devices of Examples 1 to 6 having the predetermined configuration in the predetermined order had the viewing angle controllability in the left-right direction and were always shielded from light in the up-down direction. In addition, it was found that the light shielding properties in the oblique direction during the viewing angle non-control were excellent, and the light resistance was also excellent. In addition, it was found that the liquid crystal display devices of Examples 6 to 9 also exhibited the desired effects.

On the other hand, in the liquid crystal display devices of Comparative Examples 1, 2, and 4 to 6 not having the predetermined configuration or not having the predetermined configuration in the predetermined order, both the light shielding properties in the oblique direction during the viewing angle non-control and the light resistance could not be achieved. In addition, in the liquid crystal display device of Comparative Example 3 not having the predetermined configuration, it was not possible to constantly perform the light shielding in the up-down direction.

In addition, in the liquid crystal display device of Example 5 using the B-plate, it was found that the light shielding properties in the oblique direction were more excellent. Furthermore, in the liquid crystal display device of Example 5, light leakage in directions of azimuthal angles of 45°, 135°, 225°, and 315° was suppressed, and more favorable display performance could be obtained.

### EXPLANATION OF REFERENCES

1: front viewing direction
2: first viewing direction
3: second viewing direction
10: laminate
12a, 12b: transmittance central axis
32a, 32b: absorption axis
102a: first light absorption anisotropic layer
102b: second light absorption anisotropic layer
200: second liquid crystal cell
300: liquid crystal panel
302: first liquid crystal cell
304a: first polarizer
304b: second polarizer
400: plane light source
500: liquid crystal display device

What is claimed is:

1. A laminate comprising, in the following order:
a first light absorption anisotropic layer;
a first polarizer;
a first liquid crystal cell;
a second polarizer;
a second liquid crystal cell; and
a second light absorption anisotropic layer,
wherein an absorption axis of the first polarizer is orthogonal to an absorption axis of the second polarizer,
the first light absorption anisotropic layer and the second light absorption anisotropic layer contain a dichroic substance,
an angle θ1 between a transmittance central axis of the first light absorption anisotropic layer and a normal direction of a surface of the first light absorption anisotropic layer is 0° to 45°, and
an angle θ2 between a transmittance central axis of the second light absorption anisotropic layer and a normal direction of a surface of the second light absorption anisotropic layer is 0° to 45°.

2. The laminate according to claim 1,
wherein the dichroic substance has an arrangement structure of dichroic substances in the first light absorption anisotropic layer and the second light absorption anisotropic layer.

3. The laminate according to claim 1,
wherein the first liquid crystal cell and the second liquid crystal cell are each independently selected from the group consisting of a twisted nematic type liquid crystal cell, an in-plane switching type liquid crystal cell, and a vertical alignment type liquid crystal cell.

4. The laminate according to claim 1,
wherein the second liquid crystal cell is a liquid crystal cell capable of switching an in-plane phase difference of the second liquid crystal cell between 0 and λ/2, and
in a state in which the in-plane phase difference of the second liquid crystal cell is λ/2, an angle between an in-plane slow axis direction of the second liquid crystal cell and the absorption axis of the second polarizer is in a range of 45°±10°.

5. The laminate according to claim 1,
wherein the second liquid crystal cell is a liquid crystal cell having an in-plane phase difference of λ/2 and capable of controlling an in-plane slow axis direction, and
the second liquid crystal cell is capable of controlling an in-plane slow axis such that an angle between the in-plane slow axis direction of the second liquid crystal cell and the absorption axis of the second polarizer is in a range of 45°±10° or in a range of 0°±10°.

6. A liquid crystal display device comprising:
the laminate according to any one of claim 1.

7. An in-vehicle display comprising:
the liquid crystal display device according to claim 6.

8. The laminate according to claim 2,
wherein the first liquid crystal cell and the second liquid crystal cell are each independently selected from the group consisting of a twisted nematic type liquid crystal cell, an in-plane switching type liquid crystal cell, and a vertical alignment type liquid crystal cell.

9. The laminate according to claim 2,
wherein the second liquid crystal cell is a liquid crystal cell capable of switching an in-plane phase difference of the second liquid crystal cell between 0 and λ/2, and
in a state in which the in-plane phase difference of the second liquid crystal cell is λ/2, an angle between an in-plane slow axis direction of the second liquid crystal cell and the absorption axis of the second polarizer is in a range of 45°±10°.

10. The laminate according to claim 3,
wherein the second liquid crystal cell is a liquid crystal cell capable of switching an in-plane phase difference of the second liquid crystal cell between 0 and λ/2, and
in a state in which the in-plane phase difference of the second liquid crystal cell is λ/2, an angle between an in-plane slow axis direction of the second liquid crystal cell and the absorption axis of the second polarizer is in a range of 45°±10°.

11. The laminate according to claim 2,
wherein the second liquid crystal cell is a liquid crystal cell having an in-plane phase difference of λ/2 and capable of controlling an in-plane slow axis direction, and
the second liquid crystal cell is capable of controlling an in-plane slow axis such that an angle between the in-plane slow axis direction of the second liquid crystal cell and the absorption axis of the second polarizer is in a range of 45°±10° or in a range of 0°±10°.

12. The laminate according to claim 3,
wherein the second liquid crystal cell is a liquid crystal cell having an in-plane phase difference of λ/2 and capable of controlling an in-plane slow axis direction, and
the second liquid crystal cell is capable of controlling an in-plane slow axis such that an angle between the in-plane slow axis direction of the second liquid crystal cell and the absorption axis of the second polarizer is in a range of 45°±10° or in a range of 0°±10°.

13. A liquid crystal display device comprising:
the laminate according to any one of claim 2.

14. An in-vehicle display comprising:
the liquid crystal display device according to claim 13.

15. A liquid crystal display device comprising:
the laminate according to any one of claim 3.

16. An in-vehicle display comprising:
the liquid crystal display device according to claim 15.

17. A liquid crystal display device comprising:
the laminate according to any one of claim 4.

18. An in-vehicle display comprising:
the liquid crystal display device according to claim 17.

19. A liquid crystal display device comprising:
the laminate according to any one of claim 5.

20. An in-vehicle display comprising:
the liquid crystal display device according to claim 19.
